(19) United States
(12) Patent Application Publication
(10) Pub. No.: US 2017/0285923 A1
(43) Pub. Date: Oct. 5, 2017

(54) MULTI-PERSPECTIVE APPLICATION COMPONENTS DEPENDENCIES

(71) Applicant: CA, Inc., New York, NY (US)

(72) Inventors: Erhan Giral, Daly City, CA (US); Mark Jacob Addleman, Oakland, CA (US); Corey Adam Cohen, Matawan, NJ (US)

(21) Appl. No.: 15/083,666

(22) Filed: Mar. 29, 2016

(51) Int. Cl. G06F 3/0484; G06F 3/0482; H04L 12/26

(52) U.S. Cl. CPC G06F 3/04847; H04L 43/045; H04L 43/065; G06F 3/0482

(57) ABSTRACT

A dependency graph is created that indicates dependencies among a plurality of components of an application based, at least in part, on interactions among the plurality of components determined from at least one execution of the application. In response to selection of a first attribute of a plurality of attributes, the plurality of components are differentiated into a first plurality of sets of the plurality of components based, at least in part, on having values in common for the first attribute. Dependencies among the first plurality of sets of components are determined based, at least in part, on the dependency graph. A first attribute based perspective of the application is determined, wherein the first attribute based perspective comprises a graphical container for each of the first plurality of sets of components and graphical connections between the graphical containers corresponding to the dependencies among the first plurality of sets of components.

### BACKGROUND

The disclosure generally relates to the field of computer processing, and more particularly to multi-perspective application structure and performance analysis.

The growing presence of the Internet as well as other computer networks such as intranets and extranets has brought many new applications in e-commerce, education and other areas. Organizations increasingly rely on such applications to carry out their business or other objectives. Such organizations also typically devote considerable resources to ensuring that the applications perform as expected. To this end, various application management techniques have been developed.

One approach involves monitoring the infrastructure of the application by collecting application runtime data regarding the individual software components that are invoked in the application. This approach can use agents that essentially live in the system being monitored. For example, using instrumentation of the software, a thread or process can be traced to identify each component that is invoked, as well as to obtain runtime data, such as the execution time of each component. Tracing refers to obtaining a detailed record or trace of the steps a computer program executes. One type of trace is a stack trace. Traces can be used as an aid in debugging or production performance monitoring.

However, as application complexity increases, diagnosis of problems continues to be difficult and time-consuming. For example, when a distributed transaction or application is failing or regressing, what is going wrong, why the failure is occurring, etc. needs to be determined as quickly as possible to minimize business impact.

### BRIEF DESCRIPTION OF THE DRAWINGS

Embodiments of the disclosure may be better understood by referencing the accompanying drawings.

FIG. 1 depicts a system having agents for monitoring execution of an application, according to some embodiments.

FIG. 2 depicts a flowchart of operations for starting the tracing of a transaction, according to some embodiments.

FIG. 3 depicts a flowchart of operations for concluding the tracing of a transaction, according to some embodiments.

FIG. 4A depicts a first example transaction trace which involves the application server 106 of FIG. 1.

FIG. 4B depicts a second example transaction trace which involves the application server 106 of FIG. 1.

FIG. 4C depicts a first example transaction trace which involves the application server 110 of FIG. 1.

FIG. 4D depicts an application deployment diagram based on the transaction traces of FIGS. 4A-4C, according to some embodiments.

FIG. 4E depicts paths in a dependency digraph based on the transaction traces of FIGS. 4A-4C, according to some embodiments.

FIG. 4F depicts a single JVM transaction call stack based on the transaction trace of FIG. 4A, according to some embodiments.

FIGS. 4G and 4H depict pre and post-pruning, respectively, of a dependency digraph for the call stack of FIG. 4F, according to some embodiments.

FIG. 4I depicts a cross-JVM transaction call stack based on the transaction traces of FIGS. 4B and 4C, according to some embodiments.

FIGS. 4J and 4K depict pre and post-pruning, respectively, of a dependency digraph for the call stack of FIG. 4I, according to some embodiments.

FIG. 5A depicts a dependency graph with details for Application A, based on the pruned dependency digraphs of FIGS. 4H and 4K, according to some embodiments.

FIG. 5B depicts a dependency graph with details for Application A and Application B, based on the pruned dependency digraphs of FIGS. 4H and 4K, according to some embodiments.

FIG. 6A depicts a user interface (UI) which provides a summary view of a Business Service, based on the pruned dependency digraphs of FIGS. 4H and 4K, according to some embodiments.

FIG. 6B depicts the user interface of FIG. 6A after a Business Transaction BTA1 is selected, according to some embodiments.

FIG. 7A1 depicts a user interface which provides a summary view based on the pruned dependency digraphs of FIGS. 4H and 4K, according to some embodiments.

FIG. 7A2 depicts an aging process applied to the user interface of FIG. 7A1, according to some embodiments.

FIG. 7A3 depicts another example of an aging process applied to the user interface of FIG. 7A1, according to some embodiments.

FIG. 7A4 depicts a further example of an aging process applied to the user interface of FIG. 7A1, according to some embodiments.

FIG. 7B depicts the user interface of FIG. 7A in a detailed view, according to some embodiments.

FIG. 7C depicts a user interface which provides a summary view based on the pruned dependency digraph of FIG. 4K, according to some embodiments.

FIG. 8 depicts a no group perspective of a dependency graph of application components, according to some embodiments.

FIG. 9 depicts an application perspective of a dependency graph of application components, according to some embodiments.

FIG. 10 depicts an ownership perspective of a dependency graph of application components, according to some embodiments.

FIG. 11 depicts an alternative ownership perspective of a dependency graph of application components, according to some embodiments.

FIG. 12 depicts a geographic location perspective of a dependency graph of application components, according to some embodiments.

FIG. 13 depicts a component type perspective of a dependency graph of application components, according to some embodiments.

FIG. 14 depicts a host perspective of a dependency graph of application components, according to some embodiments.

FIG. 15 depicts a flowchart of operations for providing multiple perspectives of a dependency graph of application components, according to some embodiments.

FIG. 16 depicts an example computer device, according to some embodiments.

### DESCRIPTION

The description that follows includes example systems, methods, techniques, and program flows that embody aspects of the disclosure. However, it is understood that this disclosure may be practiced without these specific details. For instance, this disclosure refers to certain attributes of application components that are the basis of the different perspectives of the dependency among application component in illustrative examples. But aspects of this disclosure can be applied to any type of attribute of application components for grouping to allow for a different perspective. In other instances, well-known instruction instances, protocols, structures and techniques have not been shown in detail in order not to obfuscate the description.

### Overview

Some embodiments provide a method for diagnosing problems in a computer system by visualizing flows through applications or other subsystems of the computer system. A tool is provided for monitoring application performance by collecting metrics and structural dependency data for applications with the help of respective agents for the applications. The metric data which is collected provides an agent-centric view of applications (including multiple instances of the same application) that are being monitored. Further, the tool can provide an easier means for the business user to interact in business-centric terms by providing a graphical dependency graph or application graph which shows the dependency relationship between an application or business process and its logical infrastructure components.

Some embodiments present a runtime description and graphical representation of the structure of applications that can be distributed across multiple servers in same or different geographic locations. For example, an application, such as a banking account application, can include multiple application components executing across multiple servers. An application component can be defined as a functionality or logical grouping of functionalities of the application. For the banking account application example, a first component can provide a service for user authentication for the banking account, a second component can provide a service to retrieve a checking account balance for the user, a third component can provide a service to retrieve a credit card balance for the user, etc. Additionally, these components might be deployed in a geographically distributed manner or owned by different organizations. Also, the application structure can change as these different components are updated to new versions. Different components can be updated at different times as long as the interfaces among the components are consistent. For example, assume that after a component upgrade, the component changes from performing an access for user authentication to a database located in the United States to performing the access to a database located in India. Some embodiments can present the runtime description and graphical representation depicting the component now accessing the database in India.

Some embodiments provide a multi-perspective view of the dependencies among multiple components of distributed application(s). Each component can have multiple attributes, such as owner, the operational tier it belongs to, technology it was built on, geographic location from which the component is being executed, the host that is executing the component, etc. A view of the dependencies among the multiple components can change from a first view to a second view based on changing selection from a first to a second attribute of the multiple components. For example, a first view of the dependencies among components can be derived from ownership of the components, while a second view of the dependencies can be derived from geographic location from which the components are being executed.

The following description includes four sections. A first section includes a description of creation of dependency graphs of application components based on component tracing and boundary compaction. A second section includes a description of creation of multi-perspective models of dependencies among the application components. A third section includes a description of an example computer device. A fourth section includes a description of possible variations of different embodiments.

### Creation of Dependency Graphs of Application Components

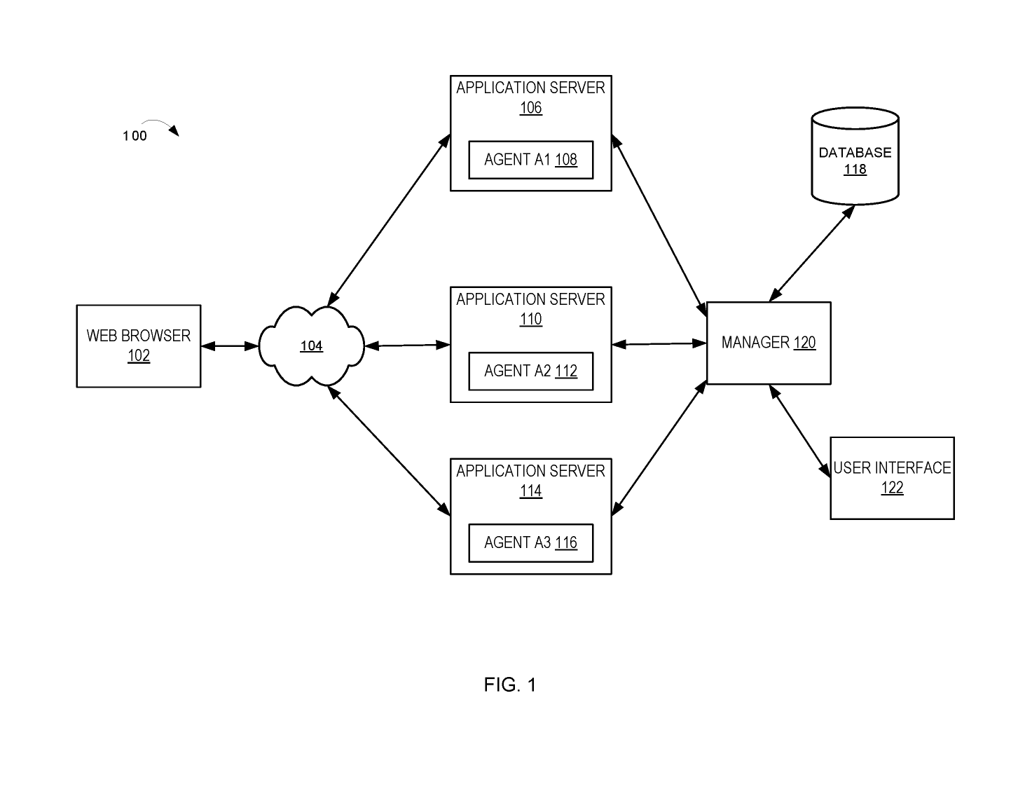

FIG. 1 depicts a system having agents for monitoring execution of an application, according to some embodiments. FIG. 1 depicts a system 100 in which different computing devices provide data to a manager. Example computing devices 106, 110 and 114 may include application servers or any other type of computing device having a processor for executing code to achieve a desired functionality. The computing devices can be located remotely from one another or co-located. The computing devices 106, 110 and 114 communicate with a local manager computer 120 in this example. The manager computer 120 could alternatively be remote from the computing devices 106, 110 and 114, in which case communication may occur via a network 104.

For example, a corporation running an enterprise application such as a web-based e-commerce application may employ a number of application servers at one location for load balancing. Requests from users, such as from an example web browser 102 of a user, are received via the network 104 such as the Internet, and can be routed to any of the computing devices 106, 110 and 114. The web browser 102 typically accesses the network 104 via an Internet Service Provider, not shown. Agent software running on the computing devices 106, 110 and 114, denoted by Agent A1 (108), Agent A2 (112) and Agent A3 (116), respectively, gather information from an application, middleware or other software, running on the respective computing devices 106, 110 and 114, in one possible approach. Such information may be obtained using instrumentation, one example of which is byte code instrumentation. However, the gathered data may be obtained in other ways as well. The agents essentially live in the computing device being monitored and provide a data acquisition point. The agents organize the data communicated to the manager 120. In one implementation, an instance of an Application A executes at the computing device 106 and an instance of an Application B executes at the computing device 110.

The manager 120 can be provided on a separate computing device such as a workstation which communicates with a user interface 122, such as a monitor, to display information based on data received from the agents. The manager 120 can also access a database 118 to store the data received from the agents. In the example provided, the computing devices can communicate with the manager 120 without accessing the network 104. For example, the communication may occur via a local area network. In other designs, the manager 120 can receive data from the agents of a number of computing devices via the network 104. For instance, some large organizations employ a central network operations center where one or more managers obtain data from a number of distributed agents at different geographic locations. To illustrate, a web-based e-commerce enterprise might obtain agent data from servers at different geographic locations that receive customer orders, from servers that process payments, from servers at warehouses for tracking inventory and conveying orders, and so forth. The manager 120 and user interface display 122 might be provided at a corporate headquarters location. Other applications which are not necessarily web-based or involve retail or other sales, similarly employ agents and managers for managing their systems. For example, a bank may use an application for processing checks and credit accounts. Moreover, in addition to the multi-computing device arrangements mentioned, a single computing device can be monitored as well with one or more agents.

Various approaches are known for configuring software to monitor its execution. For example, as mentioned at the outset, tracing may be used to track the execution of software. In one approach discussed therein, object code or bytecode of an application to be monitored is configured, e.g., modified, with probes. The probes measure specific pieces of information about the application without changing the application's business or other logic. Once the probes have been installed in the bytecode of an application, it is referred to as a monitored application. The agent software receives information from the probes and may communicate the information to another process, such as at the manager 120, or process the information locally, such as to determine whether the information indicates an abnormal condition. The agent thus collects and summarizes information received from the probes. The probes collect information as defined by a directives file. For example, the information from the probes may indicate start and stop times of a transaction or other execution flow, or of individual components within a transaction/execution flow. This information can be compared to pre-established criteria to determine if the information is within bounds. If the information is not within bounds, the agent can report this fact to the manager so that appropriate troubleshooting can be performed. The agents 108, 112 and 116 are typically aware of the software executing on the local computing device 106, 110 and 114, respectively, with which they are associated.

The probes can report a standard set of metrics which include: Common Object Request Broker Architecture (CORBA) method timers, Remote Method Invocation (RMI) method timers, thread counters, network bandwidth, JDBC update and query timers, servlet timers, Java Server Pages (JSP) timers, system logs, file system input and output bandwidth meters, available and used memory and EJB (Enterprise JavaBean) timers. A metric is a measurement of a specific application activity.

An agent reports information about transactions, which identifies resources and components which are accessed by an application. In one approach, when reporting about transactions, the word Called designates a resource. This resource is a dependency (or a sub-resource) of a parent component, which is a consumer. For example, assume that Servlet A is the first component invoked in a transaction. Under the consumer Servlet A (see below), there may be a sub-resource Called EJB. Consumers and resources can be reported by the agent in a forest-like manner. Data for a transaction can also be stored according to the tree. For example, if a Servlet (e.g. Servlet A) is a consumer of a network socket (e.g. Socket C) and is also a consumer of an EJB (e.g. EJB B), which in turn is a consumer of a JDBC (e.g. JDBC D), the tree might look something like the following:

Servlet A
Data for Servlet A
   Called EJB B
      Data for EJB B
   Called JDBC D
      Data for JDBC D
   Called Socket C
      Data for Socket C

In some embodiments, the above tree is stored by the Agent in a stack, called the Blame Stack. When transactions are started, they are pushed onto the stack. When transactions are completed, they are popped off the stack. Each transaction on the stack can have the following information stored: type of transaction, a name used by the system for that transaction, a hash map or dictionary of parameters, a timestamp for when the transaction was pushed onto the stack, and sub-elements. Sub-elements are Blame Stack entries for other components (e.g. methods, process, procedure, function, thread, set of instructions, etc.) that are started from within the transaction of interest. Using the tree as an example above, the Blame Stack entry for Servlet A would have two sub-elements. The first sub-element would be an entry for EJB B and the second sub-element would be an entry for Socket Space C. Even though a sub-element is part of an entry for a particular transaction, the sub-element will also have its own Blame Stack entry. As the tree above notes, EJB B is a sub-element of Servlet A and also has its own entry. The top (or initial) entry (e.g., Servlet A) for a transaction, is called the root component. Each of the entries on the stack can be an object.

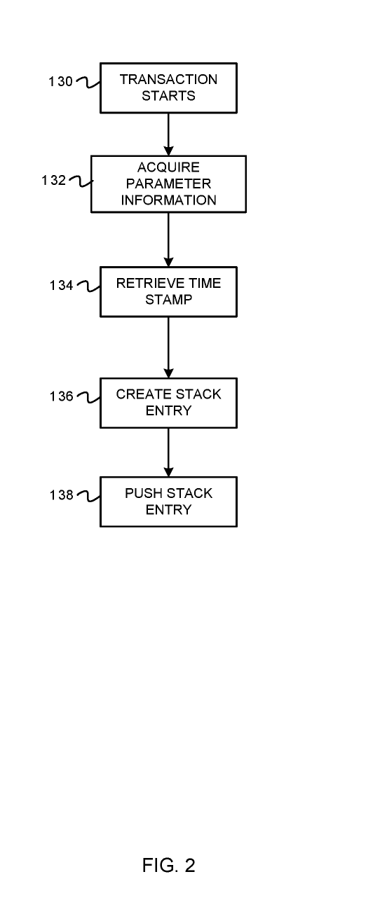

FIG. 2 depicts a flowchart of operations for starting the tracing of a transaction, according to some embodiments. The operations can be performed by the appropriate Agent(s). A transaction starts (130). In some embodiments, the process is triggered by the start of a method (e.g., the calling of a “loadTracer” method). The Agent acquires the desired parameter information (132). A user can configure which parameter information is to be acquired via a configuration file or a UI. The acquired parameters can be stored in a hash map or dictionary, which is part of the object pushed onto the Blame Stack. In other embodiments, the identification of parameters is pre-configured. There are many different parameters that can be stored. The actual list of parameters used can be dependent on the application being monitored. The table below provides examples of some parameters that can be acquired.

| Parameters | Appears in | Value |
|---|---|---|
| UserID | Servlet, JSP | The UserID of the end-user |
| | | invoking the http servlet request. |
| URL | Servlet, JSP | The URL passed through to the |
| | | servlet or JSP, not including the |
| | | Query String. |
| URL Query | Servlet, JSP | The portion of the URL that specifies |
| | | query parameters in the http request |
| | | (text that follows the ‘?’ delimiter). |
| Dynamic | Dynamic JDBC | The dynamic SQL statement, either |
| SQL | Statements | in a generalized form or with all the |
| | | specific parameters from the current |
| | | invocation. |
| Method | Blamed Method | The name of the traced method. If the |
| | Timers (everything | traced method directly calls another |
| | but Servlets, | method within the same component, |
| | JSP's and | only the “outermost” first |
| | JDBC Statements) | encountered method is captured. |
| Callable | Callable JDBC | The callable SQL statement, either |
| | statements | SQL in a generalized form or with all |
| | | the specific parameters from the |
| | | current invocation. |
| Prepared | Prepared JDBC | The prepared SQL statement, either |
| SQL | statements | in a generalized form or with all |
| | | the specific parameters from the |
| | | current invocation. |
| Object | All non-static | toString( ) of the this object of the |
| | methods | traced component, truncated to some |
| | | upper limit of characters. |
| Class Name | All | Fully qualified name of the class of |
| | | the traced component. |
| Param_n | All objects with | toString( ) of the nth parameter |
| | WithParams | passed to the traced method of |
| | custom tracers | the component. |
| Primary Key | Entity Beans | toString( ) of the entity bean's |
| | | property key, truncated to some upper |
| | | limit of characters. |

Parameters can include query, cookie, post, URL and session type name/value pairs.

The system acquires a timestamp indicating the current time (134). A stack entry is created (136). The stack entry is pushed onto the Blame Stack (138). The timestamp can be added as part of operations at 138. The process is performed when a transaction is started. A similar process is performed when a sub-component of the transaction starts (e.g., EJB B is a sub-component of Servlet A—see tree described above).

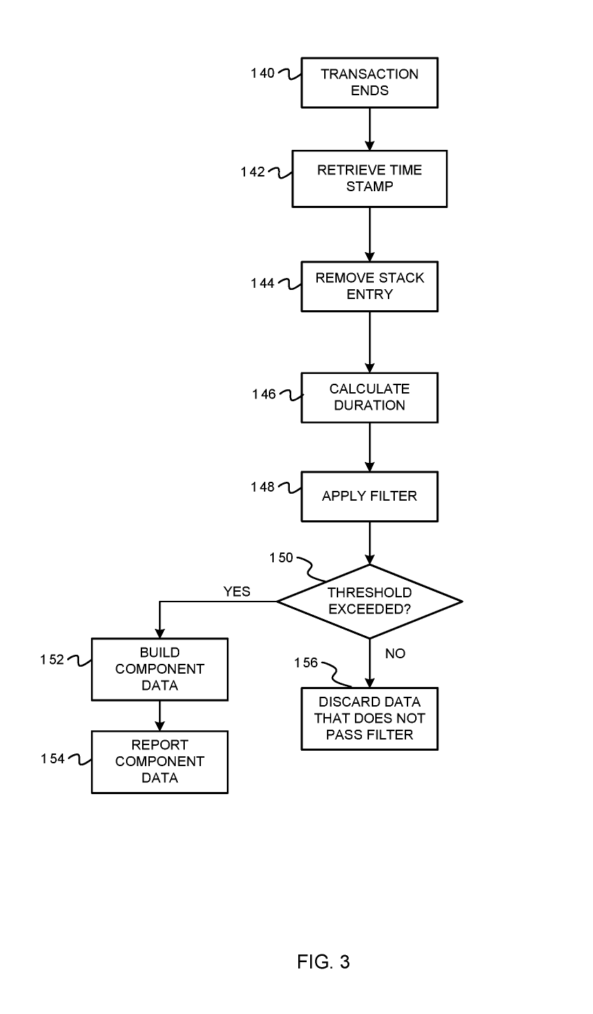

FIG. 3 depicts a flowchart of operations for concluding the tracing of a transaction, according to some embodiments. The process can be performed by an Agent when a transaction ends. The process is triggered by a transaction (e.g., method) ending (e.g., calling of a method “finishTrace”) (140). The system acquires the current time (142). The stack entry is removed (144). The execution time of the transaction is calculated by comparing the timestamp from 142 to the timestamp stored in the stack entry (146). The filter for the trace is applied (148). For example, the filter may include a threshold period of one second. Thus, operations at 148 would include determining whether the calculated duration from 146 is greater than one second. If the threshold is not exceeded (150), then the data for the transaction is discarded. In some embodiments, the entire stack entry is discarded. In some other embodiments, only the parameters and timestamps are discarded. In other embodiments, various subsets of data can be discarded. In some embodiments, if the threshold period is not exceeded then the data is not transmitted by the Agent to other components in the system of FIG. 1. If the duration exceeds the threshold (150), then the Agent builds component data at 160. Component data is the data about a transaction that will be reported. The component data can include the name of the transaction, the type of the transaction, the start time of the transaction, the duration of the transaction, a hash map or dictionary of the parameters, and all of the sub-elements (which can be a recursive list of elements). Other information can also be part of the component data. The Agent reports the component data by sending the component data via the TCP/IP protocol to Manager 120 (162).

FIG. 3 represents what happens when a transaction finishes. When a sub-component finishes, however, operations include getting a time stamp, removing the stack entry for the sub-component and adding the completed sub-element to previous stack entry. In some embodiments, the filters and decision logic are applied to the start and end of the transaction, rather than to a specific sub-component.

In some embodiments, if the transaction tracer is off, the system will still use the Blame Stack; however, parameters will not be stored and no component data will be created. The system can default to starting with the tracing technology off. The tracing can start after a user request, as described above.

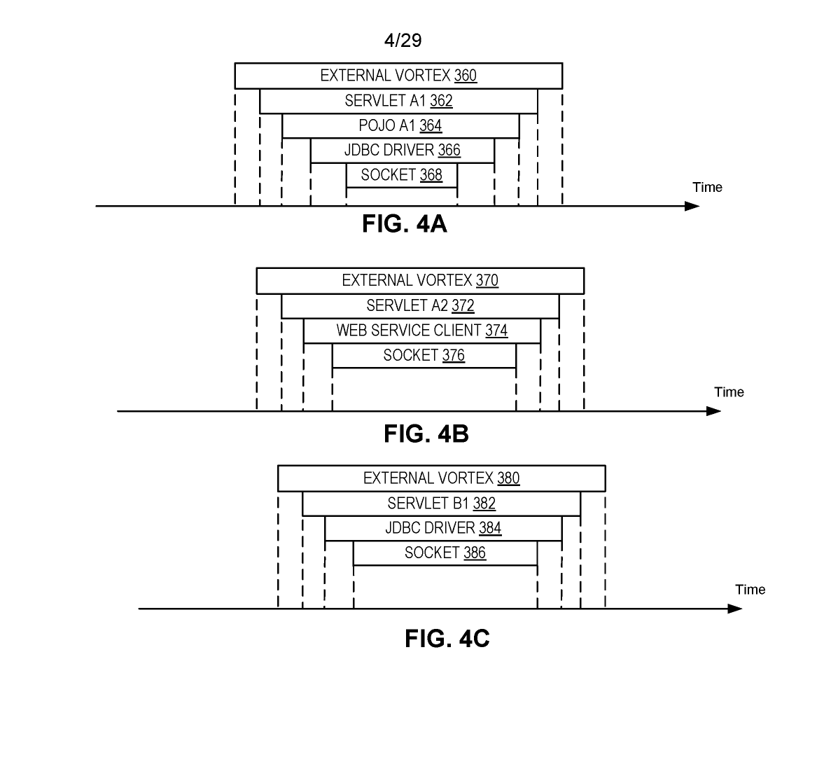

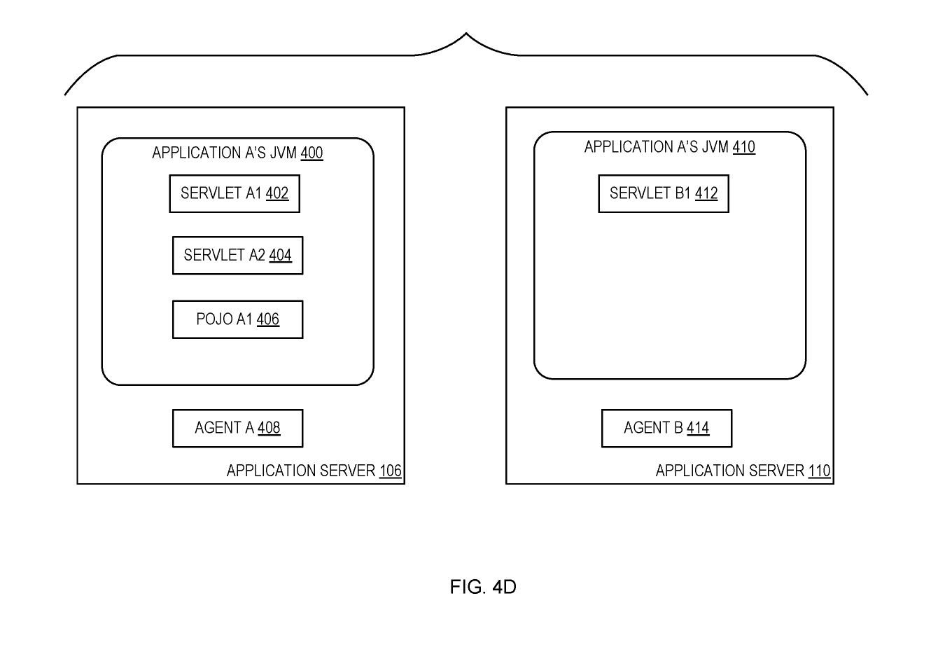

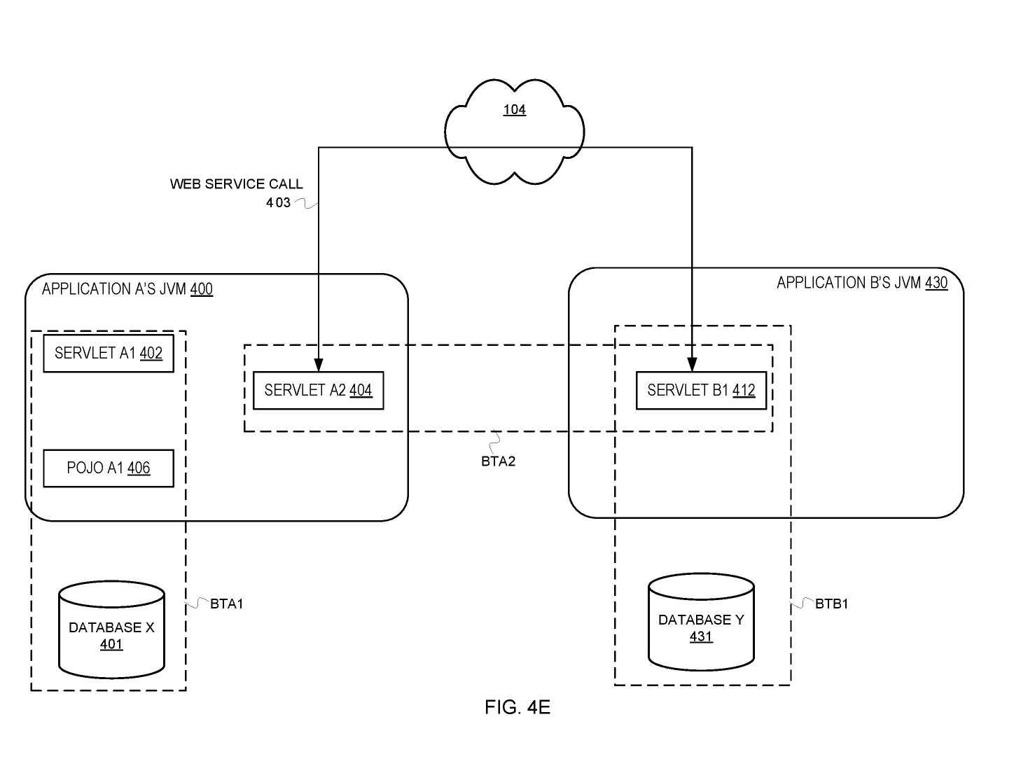

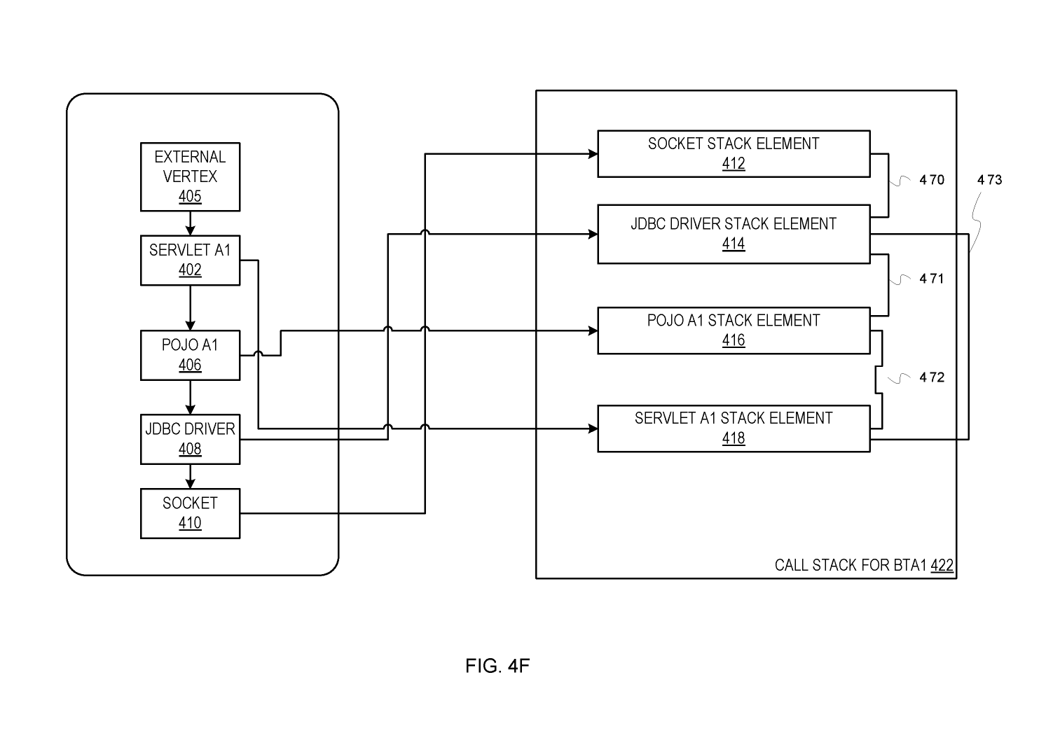

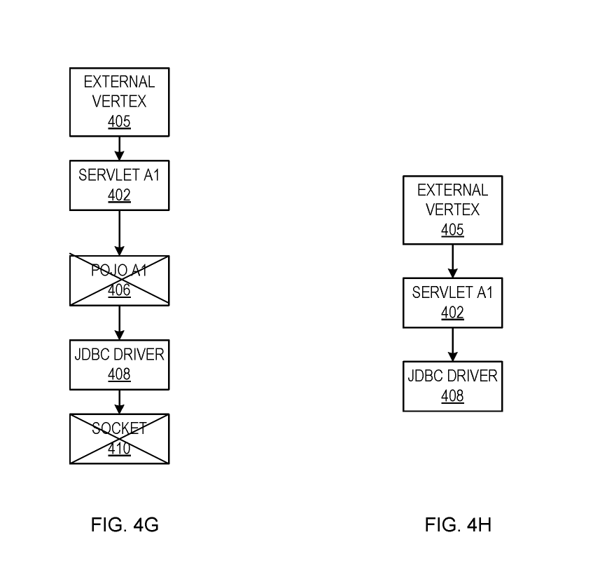

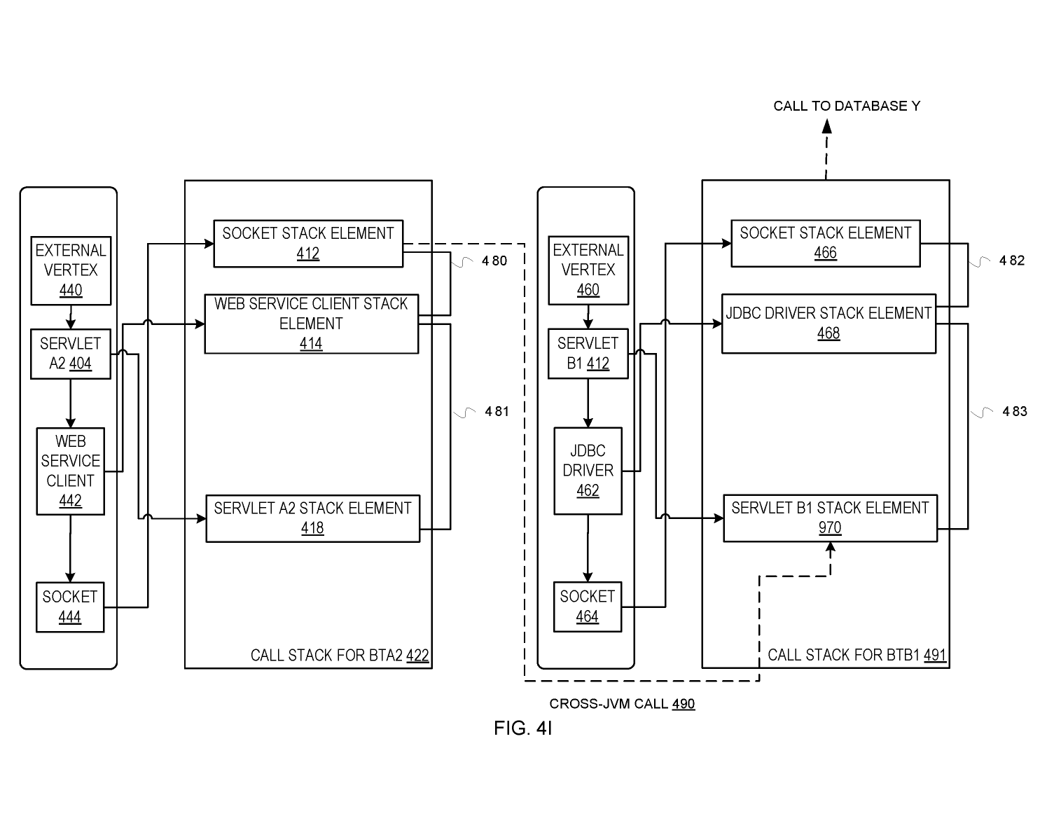

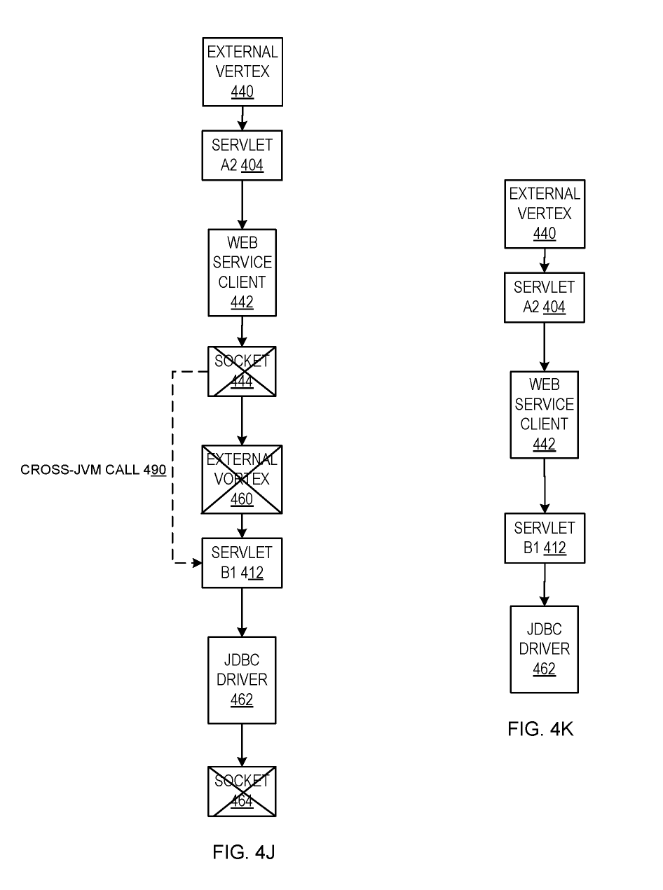

FIG. 4A depicts a first example transaction trace which involves the application server 106 of FIG. 1. A transaction trace of a thread or process can be obtained to identify each component that is invoked, and the calling relationships among the components. This example transaction trace is considered to be part of a business transaction BTA1 (see FIG. 4E). In one approach, the transaction trace is of an application which is considered to be invoked by a first business transaction (BTA1) by virtue of at least a first preselected component such as Servlet A1 of the first application being invoked.

In the transaction trace, the horizontal direction represents time, while the vertical direction indicates call stack depth or position. A transaction trace, also referred to as a call stack, identifies instrumented components which have been called or invoked during the execution of one or more programs, processes or threads. Trace data of instrumented components can be used along with dependency data to understand and debug an application. In particular, a separate transaction trace can be provided for each agent, such that different threads are separated out into different transaction traces.

In a graphical representation which can be provided on a user interface display and/or stored in a data store, an external vertex 360 is the first or root component of the transaction trace. A Servlet A1 362, a Plain Old JAVA™ Object (POJO) A1 364, a Java Database Connectivity (JDBC) driver call 366 and a socket call 368 are at successively lower layers of the transaction trace. A POJO is a JAVA object which is not a special object such as an Enterprise JavaBean (EJB). The external vertex 360 can be any component that calls Servlet A1 in Application A from outside Application A.

FIG. 4B depicts a second example transaction trace which involves the application server 106 of FIG. 1. An external vertex 370 (which can be different than the external vertex 360) is the root component of the transaction trace. A Servlet A2 372, a Web Service Client 374 and a socket call 376 are at successively lower layers of the transaction trace. The external vertex 370 can be any component that calls Servlet A2 in Application A from outside Application A.

FIG. 4C depicts a first example transaction trace which involves the application server 110 of FIG. 1. An external vertex 380 (which can be different than the external vertexes 360 and 370) is the root component of the transaction trace. A Servlet B1 382, a JDBC driver call 384 and a socket call 386 are at successively lower layers of the transaction trace. The external vertex 380 can be any component that calls Servlet B1 in Application B from outside Application B.

The transaction traces of FIGS. 4A-4C provide a basis for the discussion of FIGS. 4D-7E.

FIG. 4D depicts an application deployment diagram based on the transaction traces of FIGS. 4A-4C, according to some embodiments. Application A is deployed in the application server 106, and Application B is deployed in the application server 110, in this example. The Java Virtual Machine (JVM) 400 of Application A executes Servlet A1 402, Servlet A2 404 and POJO A1 406, while Agent A 408 monitors the execution. In the application server 110, the Java Virtual Machine (JVM) 420 of Application B executes Servlet B1 412, which is exposed as a Web Service, while Agent B 414 monitors the execution.

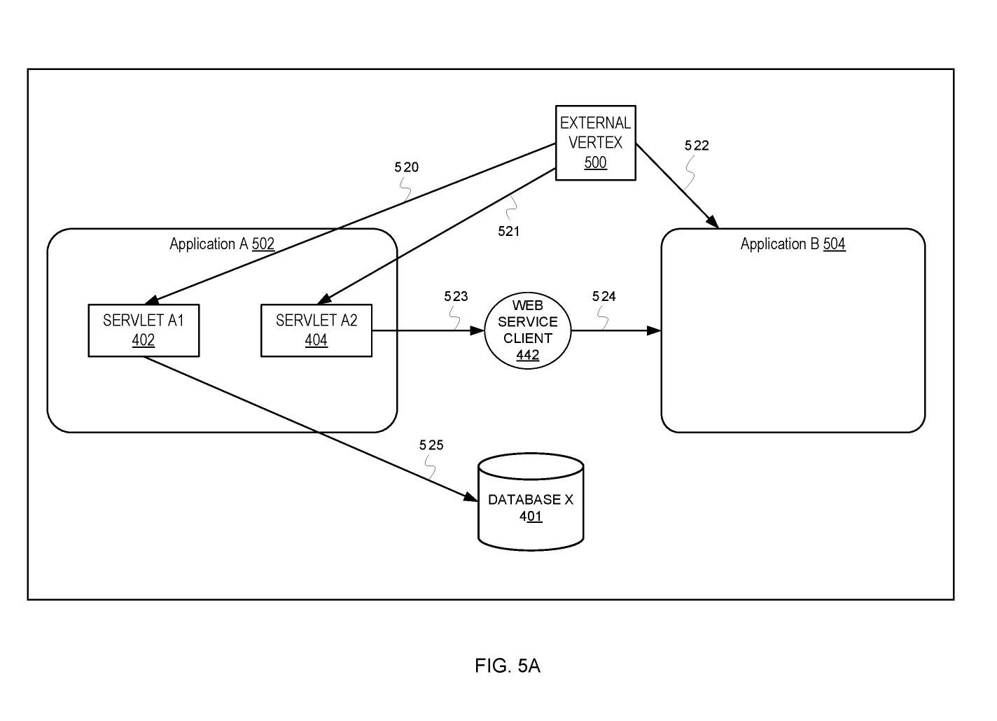

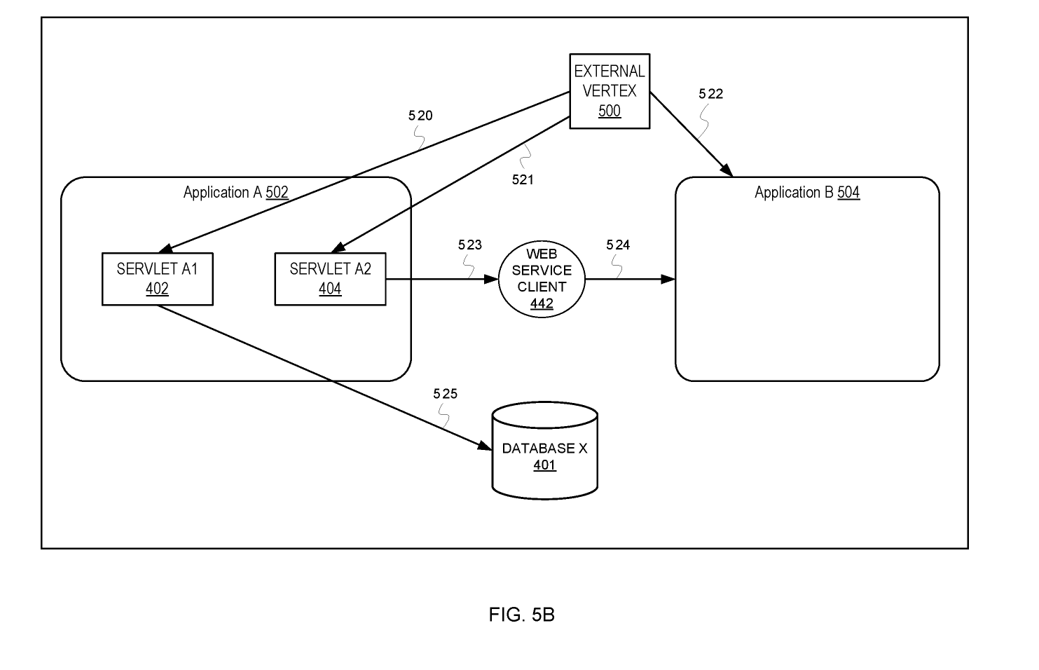

A dependency graph can be provided based on this example (See FIGS. 5A-7D). A dependency graph displays a dependency relationship (map) between various software components of an application or business transactions as a directed graph (digraph). The software components can be Servlets, EJBs, Databases, message queues (MQs) and so forth.

Specifically, a graph G=(V, E) includes a set V of vertices (also called nodes), and a set E of edges. Each edge represents an ordered pair of vertices. The edges in a directed graph are ordered pairs, i.e., the two vertices the edge connects are ordered. A directed graph edge can be drawn as an arrow pointing from one vertex (source) to another (target). Thus, the head of the arrow is at the target vertex and the tail of the arrow is at the source vertex. Further, a simple path from v1 to vk is a sequence of vertices v1, v2 . . . vk that are connected by edges (v1, v2), (v2, v3) . . . (vk−1, vk). If an application is represented by a directed graph, then a business transaction can be considered as a simple path through that graph. A subgraph S of a graph G is a graph whose vertices and edges are subsets of vertices and edges of graph G. A subgraph S1 is called edge induced subgraph of G, if it consists of a subset of edges of graph G. A business service can be considered as an edge-induced subgraph of that graph. The logical view of the dependency graph is the union of all physical dependencies between various components across agents. Potentially, an application dependency graph may depict multiple business transactions.

FIG. 4E depicts paths in a dependency digraph based on the transaction traces of FIGS. 4A-4C, according to some embodiments. In Application A, Servlet A1 402 calls POJO A1 406, which in turn calls Database X 401. Servlet A2 404 makes a Web Service call 403 via the network 104 to Servlet B1 412 of Application B, in response to which Servlet B1 calls Database Y 431. A Business Transaction BTA1 can be defined as the execution flow (series of invoked components/subsystems) from Servlet A1 to POJO A1 to Database X, while a Business Transaction BTA2 can be defined as the flow from Servlet A2 to the Web Service to Servlet B1. Moreover, the transaction BTA2 generates a Business Transaction BTB1 with respect to Application B. BTB1 can be defined as the flow from Servlet B1 to Database Y.

Generally, the agent can track components of every transaction passing through an application/web server. The software components (such as class-method pairs) involved in a transaction are pushed inside a call stack in the order in which they are invoked. A component is popped out of the call stack when a control flow returns to it. However, a transaction call stack includes a number of components which may or may not be of interest to a user. To prevent unnecessarily complex dependency graphs, the agent may only collect dependencies between nodes of interest. A component which is the first interesting element in the call stack or a component that makes a call outside its own JVM (Java Virtual Machine) call can be considered for the dependency graph.

The first component pushed in the call stack may not always be an interesting component. The first interesting component in the call stack is marked as a frontend. A call outside the JVM typically involves a socket. A socket appearing as the last component in a transaction may not always be interesting to the user. We can provide a mechanism for marking any component before the socket call as a component of interest. The interesting component which is before the socket call, closest to the socket call, is marked as a backend. We can provide a few predefined interesting component types, e.g., Servlet, EJB, JDBC/database and so forth in a baseline configuration. A user can extend the interesting types by a tracer extension capability.

Further, in the dependency graph, an edge consists of source and target vertices, and the starting edge is between an external vertex and the front end component. The starting vertex is usually represented either by a cloud or an external component.

FIG. 4F depicts a single JVM transaction call stack based on the transaction trace of FIG. 4A, according to some embodiments. BTA1 is an example of a single JVM transaction, which is confined within a calling application's JVM. BTA1 is confined within Application A's JVM. In one possible implementation, the external vertex 405 is provided by an incoming HTTP request, which invokes Servlet A1 402, which in turn calls POJO A1 406. POJO A1 in turn calls Database X. The call to the database is routed through a JDBC driver 408, which is a software component providing database connectivity to JAVA applications. The inter-process communication flow from the JDBC driver 408 to the actual physical database, Database X, passes through a Socket 410.

The call stack for BTA1 422 includes a Servlet A1 stack element 420, a POJO A1 stack element 416, a JDBC driver stack element 414 and a Socket stack element 412. Based on these stack elements, edges between the elements can be defined for use in creating the dependency graph. These include an edge 472 which indicates that Servlet A1 depends on POJO A1, an edge 471 which indicates that POJO A1 depends on the JDBC driver, and an edge 470 which indicates that JDBC driver depends on a socket call.

FIGS. 4G and 4H depict pre and post-pruning, respectively, of a dependency digraph for the call stack of FIG. 4F, according to some embodiments. As mentioned, some components are not considered to be interesting and can therefore be pruned before preparing the dependency graph. For example, assuming that POJO A1 is not of interest, the edge 472 between Servlet A1 and POJO A1 can be discarded. Instead, an edge 473 is considered to extend between Servlet A1 and the JDBC driver. Similarly, assume the edge 470 between the JDBC driver and the Socket is not treated as being important, due to the JDBC driver being marked as a backend. With this example, the call sequence of FIG. 4G is pruned by removing POJO A1406 and the socket 410 to obtain the call sequence of FIG. 4H.

FIG. 4I depicts a cross-JVM transaction call stack based on the transaction traces of FIGS. 4B and 4C, according to some embodiments. A cross-JVM transaction involves multiple JVMs and transaction call stacks. BTA2 is an example of a cross-JVM Business Transaction. In one possible implementation, the external vertex 440 is provided by an incoming HTTP request, which invokes Servlet A2 402, which in turn calls a Web Service Client 442. That is, a Web Service call from Servlet A2 to Servlet B1 412 is routed through an inter-process Socket 444. This call is the cross-JVM call 490. The call stack for BTA2 452 includes a Servlet A2 stack element 450, a Web Service Client stack element 448 and a Socket stack element 446. Based on these stack elements, edges between the elements can be defined for use in creating the dependency graph. These include an edge 481 which indicates that Servlet A2 depends on a Web Service Client, and an edge 480 which indicates that the Web Service Client depends on a socket call.

For BTB1, the external vertex 460 can represent the incoming call from Application A. This invokes Servlet B1 412, which in turn calls a JDBC driver 462. The JDBC driver 462 makes a call to Database Y via socket 464. The call stack for BTB1 491 includes a Servlet B1 stack element 470, a JDBC driver stack element 468 and a Socket stack element 466. Based on these stack elements, edges between the elements can be defined for use in creating the dependency graph. These include an edge 483 which indicates that Servlet B1 depends on a JDBC driver, and an edge 482 which indicates that the JDBC driver depends on a socket call. Note that the database call from Servlet B1 to Database Y is not only part of a single JVM Business Transaction BTB1 but also part of the cross-JVM Business Transaction BTA2. Thus, a given component/subsystem can be part of one or more Business Transactions.

In one example, the edges to the Sockets in both the Business Transactions BTA2 and BTB1 are not considered important due to the appearances of backend markers before the Sockets. In this case, edges 480 and 482 can be pruned, leaving the edges 481 and 483.

FIGS. 4J and 4K depict pre and post-pruning, respectively, of a dependency digraph for the call stack of FIG. 4I, according to some embodiments. In the above-mentioned example, the call sequence of FIG. 4J is pruned by deleting the Sockets 444 and 464. The external vertex 460 is also pruned since it is essentially replaced by the Web Service Client 442.

FIG. 5A depicts a dependency graph with details for Application A, based on the pruned dependency digraphs of FIGS. 4H and 4K, according to some embodiments. The Business Transactions BTA1 and BTA2 are considered part of Application A's dependency graph. BTA1 and BTA2 are combined to form one dependency diagraph or map of Application A. The JDBC driver invoked in BTA1 is labeled with the name of the calling physical database, Database X. Since Servlet A1 402 and Servlet A2 404 are front ends for Application A at different instances, they are grouped together inside a vertex or node 502 named Application A.

The detailed dependency graph view of an application shows all its relationships/edges with all the called backends, including any cross-JVM relationship with other applications, such as depicted by the Application B node 504. The edges are also shown, including an edge 525 between Servlet A1 402 and Database X 401, and edge 523 between Servlet A2 404 and Web Service Client 442, and an edge 524 between Web Service Client 442 and Application B 504. The vertices for Servlet B1 and Database Y and the edges between Servlet B1 and Database Y are not shown as a default, in one option, since the focus is on Application A. Optionally, these items can be shown based on a user command, for instance, as depicted in FIG. 5B. A common generalized external vertex 500 is depicted for Application A and Application B, showing an edge 520 to Servlet A1, an edge 521 to Servlet A2 404 and an edge 522 to Application B 504.

FIG. 5B depicts a dependency graph with details for Application A and Application B, based on the pruned dependency digraphs of FIGS. 4H and 4K, according to some embodiments. In this option, the vertex or nodes 412 and 431 for Servlet B1 and Database Y, respectively, are shown, along with the outgoing edge 526 between Servlet B1 412 and Database Y 431. The user can select this option to view more detail regarding one or more Business Transactions under diagnosis. In this example, Application B is invoked, and is part of, the Business Transaction BTB1. Servlet B1 is the only front end of Application B and is displayed inside the node 504 named Application B. Generally, the user can select summary or detailed views of the applications in the dependency graph.

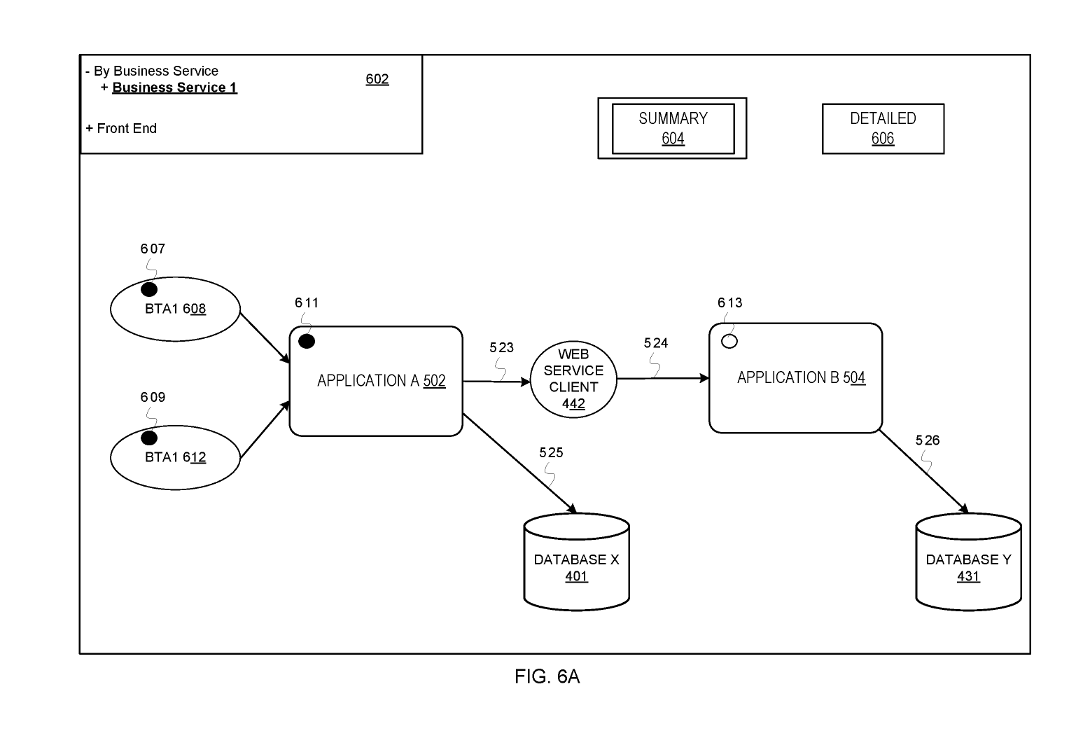

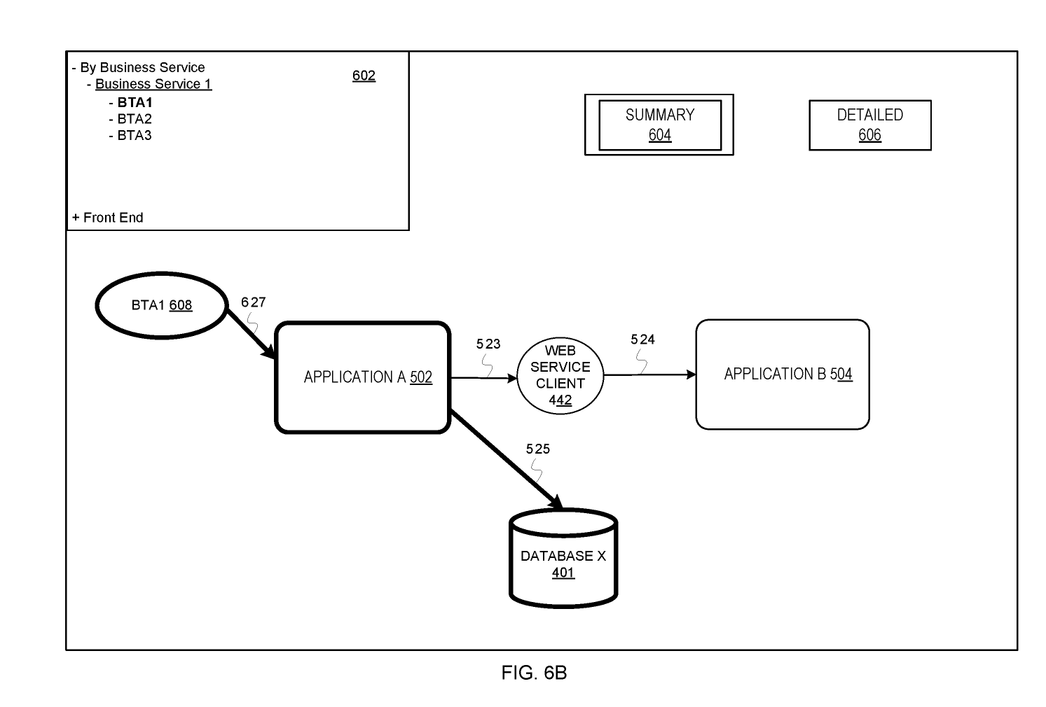

FIG. 6A depicts a user interface (UI) which provides a summary view of a Business Service, based on the pruned dependency digraphs of FIGS. 4H and 4K, according to some embodiments. The UI 600 includes a tree region 602 with labeled nodes which the user can expand or collapse, and select. The tree includes a node which can be selected to provide a Business Service view, where an example sub-node of Business Service 1 is provided, and a node which can be selected to provide a front end view. Business Service 1 has been selected by the user, as indicated by the bolded, underlined, italicized text, and the current display of a dependency graph 601 is based on this selection. A button 604 is selected to provide a summary view of the dependency graph 601, while a button 606 could be selected to alternatively provide a detailed view.

A Business Service can include multiple Business Transactions interacting with each other to accomplish a common shared goal such as to execute a stock trade for a stock trading web site, buy a book for a book-selling web site, or enroll in benefits for a company's benefits program. In our example, BTA1 and BTA2 are Business Transactions which are part of the same Business Service (Business Service 1). The summary of a Business Service can be defined by a dependency graph which provides a union of all vertices and edges included in BTA1 and BTA2. Moreover, additional placeholder nodes 608 and 612 can be provided to represent BTA1 and BT2, respectively. In this view, no special highlighting is provided for the edges and nodes.

The dependency graph can be geared towards first and second level triggers, whose roles include monitoring applications/transactions and notifying appropriate business and IT owners if any problems are encountered by a particular application/transaction. For these purposes, it can be sufficient to identify an application without specifying a component of the application. Since the detailed view of an application may become complicated with the increase in the number of applications and interesting software components, the summary dependency graph view of an application is helpful because it reduces the complexity by hiding lower level details from the user.

In the summary view, all the front end components of an application are hidden in the application node. The edges coming out from an application to its back end components are depicted, in addition to cross-JVM edges. Further, the application nodes can be decorated with application metrics, while the edges (e.g., between applications and their backends, and between applications and cross-JVM applications) can be decorated with backend relational metrics. The edges between an application node and certain backend types (e.g., Web Service and EJB back ends) can be grouped together to reduce the complexity of the summary dependency graph view. Users are allowed to create alerts on these nodes and edges to monitor the health of an application and its relationship with its back ends. An alert icon for a vertex or an edge shows up if an alert is set on their performance metric. The alert icon is an indicator of an application's performance and helps the user monitor and diagnose the health of an application and its back ends. In one approach, the alert icon is a color coded circle which can appear in one of several states: normal (green), caution (yellow) or danger (red). For simplicity, a dark circle here indicates a danger or abnormal state and an open circle indicates a normal state.

For example, the Application B node 504 has an alert icon 613 indicating a normal state for the metrics of Application B. The Application A node 502 has an alert icon 611 indicating a danger state for the metrics of Application A. As a result, the BTA1 node 608 and the BTA2 node 612 also have alert icons 607 and 609, respectively, which also indicate a danger state for these Business Transactions as a whole. The alert icon 611 is set based on aggregated metrics across multiple instances of Application A, such as an average response time. Similarly, the alert icon 613 is set based on aggregated metrics across multiple instances of Application B.

The user can select one of the Business Transactions to cause the dependency graph to be modified to provide information which is specific to the selected Business Transaction, as discussed in connection with FIGS. 6B-6D. This selection can be made, e.g., by using a pointing device such as a mouse which is placed over one of the nodes 608 and 612, or via the tree in region 602.

The dependency graph 601 graphically depicts: (a) a first node (such as node 502) which represents multiple instances of a first application (such as Application A), (b) a second node (such as node 504, 401 or 431) which represents one subsystem on which the first application depends (such as Application B, Database X or Database Y, respectively) and (c) at least one edge/arrow which represents a dependency of the first application on the one subsystem. For example, edges 523 and 525 represent a dependency of Application A on Application B, edge 525 represents a dependency of Application A on Database X and edges 523, 524 and 526 represent a dependency of Application B on Database Y. One subsystem can depend on another subsystem directly, such as when the one subsystem calls the another subsystem, or indirectly, such as when the one subsystem calls an intermediate subsystem that calls the another subsystem (or the intermediate subsystem calls another intermediate subsystem that calls the another subsystem, and so forth). Generally, a subject subsystem can be said to depend on any downstream subsystem in an execution flow or sequence of invoked resources.

The first node can represent different instances of the first application which have different front end components. For example, one instance of Application A can have the front end component Servlet A1 and another instance of Application A can have the front end component Servlet A2 (see FIG. 4E).

The first node can represent different instances of the first application which are invoked in different business transactions. For example, one instance of Application A can be invoked in BTA1 (but not BTA2) and another instance of Application A be invoked in BTA2 (but not BTA1) (see FIG. 4E).

The first node can represent different instances of the first application which are called by different external components. For example, one instance of Application A can be called by the external vertex 360 (FIG. 4A) and another instance of Application A can be called by external vertex 370 (FIG. 4B).

The first node can represent one instance of the first application which depends on one subsystem, and another instance of the one of the respective applications which does not depend on the one subsystem. For example, one instance of Application A may depend on Database X while another instance of Application A does not access Database X such as due to an error or network failure or availability.

The dependency graph can also graphically depict: (d) a third node which represents another subsystem, and (e) at least one edge which represents a dependency of the first application on the another subsystem. For example, consider the first node as node 502 of Application A as a first application, the second node 504 of Application B as one subsystem which Application A depends on, and the third node 401 of Database X as another subsystem which Application A depends on. The edges 525 can represent a dependency of Application A on Database X 401. It is possible for one instance of Application A to depend on Application B but not Database X, and for another instance of Application A to depend on Database X but not Application B.

Further, the dependency graph can graphically depict: (a) a first node (e.g., node 502) which represents multiple instances or deployments of one application (e.g., Application A) of a number of respective applications, (b) a second node (e.g., node 504) which represents multiple instances of another application (e.g., Application B) of the respective applications, and (c) at least one edge (e.g., 523, 524) which represents a dependency of the one of the respective applications on the another of the respective applications.

At least one instance of the one of the respective applications can call at least one instance of the another of the respective applications via a web service (e.g., Web Service Client 442), and the dependency graph graphically depicts the web service.

At least one instance of the one of the respective applications can call at least one instance of the another of the respective applications via a cross-JVM call (e.g., the call from Application A to Application B is a cross-JVM call—see FIG. 4I).

The first node can represent at least one instance of the one of the respective applications (e.g., Application A) which calls the another of the respective applications (e.g., Application B), and another instance of the one of the respective applications which does not call the another of the respective applications. For example, as mentioned, due to an error or network availability, one subsystem may or may not call another subsystem at different times.

The dependency graph 601 advantageously aggregates multiple instances of BTA1 and BTA2 to provide a view of all paths and subsystems which are invoked in a given time period.

FIG. 6B depicts the user interface of FIG. 6A after a Business Transaction BTA1 is selected, according to some embodiments. Note that the BTA1 node is highlighted in the tree region 602. The summary view of a Business Transaction can display the flow of transactions over an application summary view. All of the nodes called from a front end can be included in the view even though they are not part of the Business Transaction. However, only the nodes and edges which are part of the Business Transaction are highlighted, in one approach. This includes nodes 608, 502 and 401 and the edges 627 and 525 between them. An incoming edge to an application may not be included if the incoming edge is not part of the Business Transaction. Here, in the UI 610, a summary view of the Business Transaction BTA1 is provided by the dependency graph 603. Though the edge 523 between Application A 502 and Web Service 442, and the edge 524 between Web Service 442 and Application B 504 are not part of BTA1, they are still displayed, but not highlighted. The edges which are part of BTA1 (627 and 525) are highlighted since they are part of BTA1. Since Application B is not part of BTA1, the edge between Application B 504 and Database X 431 is not displayed, in one approach.

The highlighting can be achieved using various visual techniques such as different colors, thicker node borders and edges (as is done here) and so forth.

The dependency graph 603 advantageously aggregates multiple instances of BTA1 to provide a view of all paths and subsystems which are invoked in a given time period for BTA1.

In the dependency graphs which are specific to a selected Business Transaction, alert icons and metrics can be provided which are also specific to the selected Business Transaction. For example, a metric or alert icon for Application A can be aggregated over instances of Application A which were invoked in connection with BTA1, but not over instances of Application A which were invoked in connection with another Business Transaction such as BTA2.

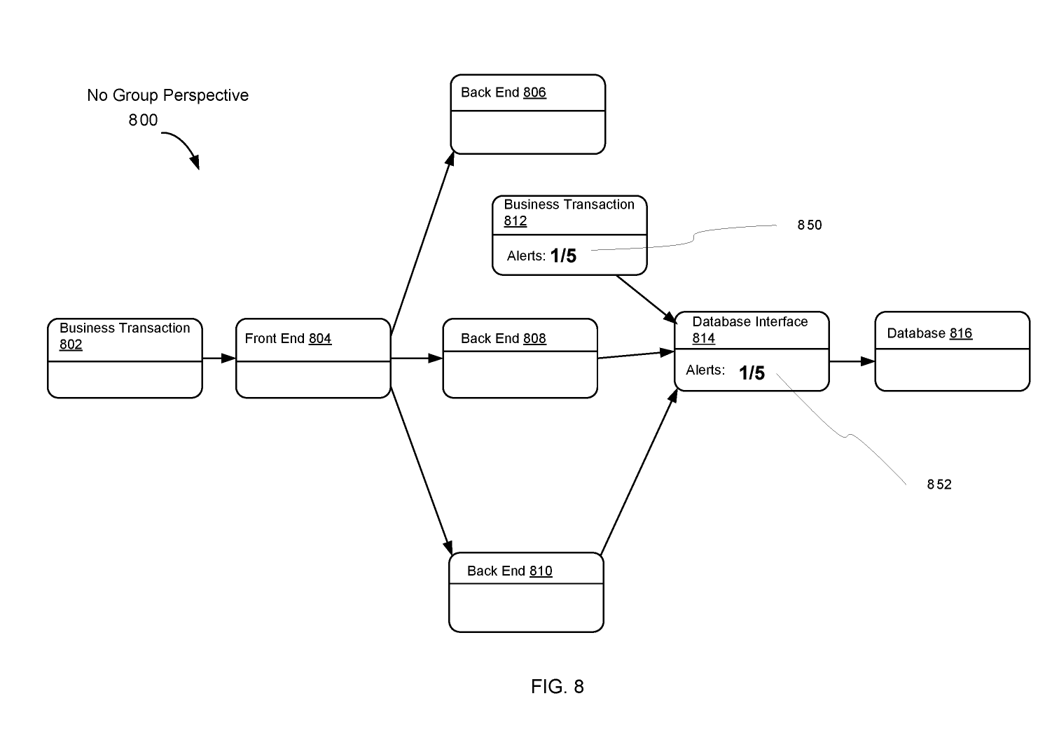

The dependency graph can graphically depict: (a) a first identifier (e.g., BTA1 in node 608) which represents a first business transaction (BTA1) in which a first application (e.g., Application A) is invoked, (b) a node (e.g., 502) which represents multiple instances of the first application, (c) a node (e.g., 401) which represents one subsystem (e.g., Database X) on which the first application depends, in connection with the first business transaction, and (d) at least one edge (e.g., 525) which represents a dependency of the first application on the one subsystem, in connection with the first business transaction. The instances of Application A and Database X may be connected to BTA1 because they are invoked in execution flows which are associated with BTA1 by virtue of one of more Business Transaction Components being invoked in the execution flows (see also FIG. 8A).

The first identifier can be graphically depicted by a node (e.g., 608) connected by at least one edge (e.g., 627) to the node (e.g., 502) which represents the multiple instances of the first application.

The first application can also be invoked in a second business transaction (e.g., BTA2—see FIG. 6C). In this case, the dependency graph can graphically depict: (e) a second identifier (e.g., BTA2 in node 612) which represents the second business transaction, (f) a node (e.g., Application B) which represents another subsystem on which the first application depends, in connection with the second business transaction, and (g) at least one other edge (e.g., 523, 524) which represents a dependency of the first application on the another subsystem, in connection with the second business transaction.

Responsive to a user selection of the first business transaction (e.g., node 608), the dependency graph visually distinguishes the first identifier over the second identifier, and possibly other Business Transaction identifiers, the node which represents the one subsystem over the node which represents the another subsystem, and the at least one edge over the at least one other edge, as shown in FIG. 6B.

The first application can be invoked by the first business transaction by virtue of at least a first preselected component (e.g., Servlet A1—see FIG. 4E) of the first application being invoked, and the first application can also be invoked by the second business transaction by virtue of at least a second preselected component (e.g., Servlet A2—see FIG. 4E) of the first application being invoked.

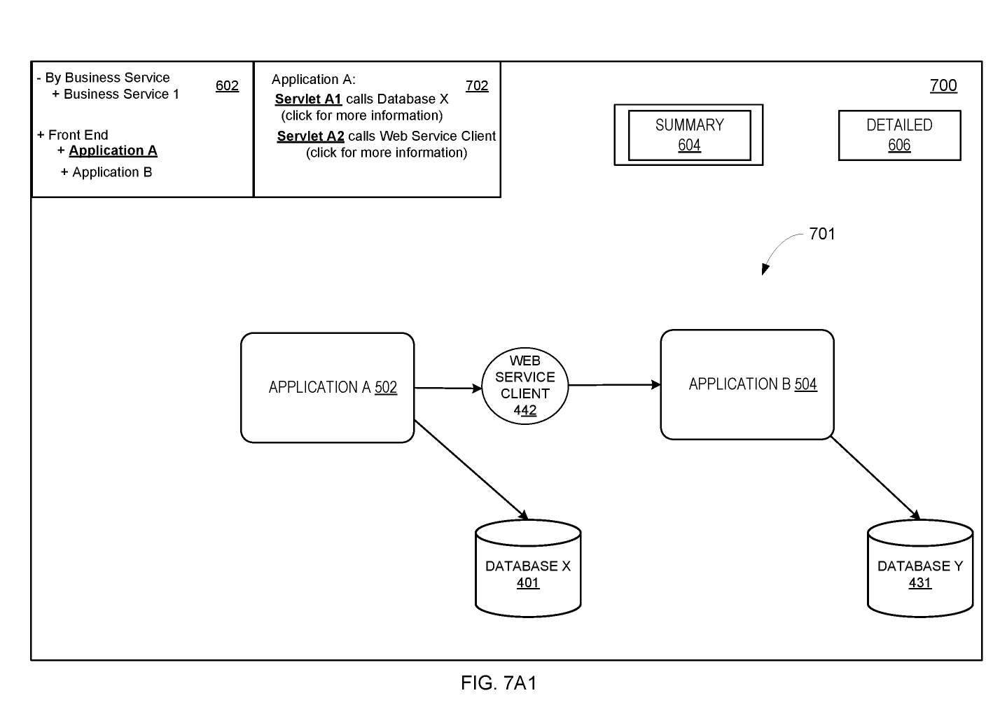

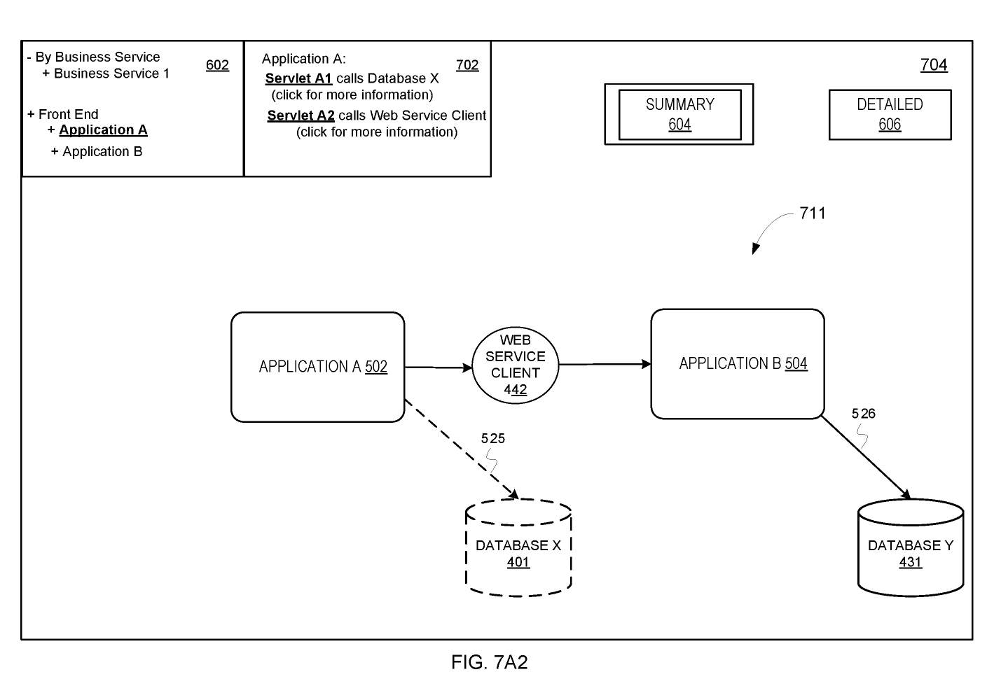

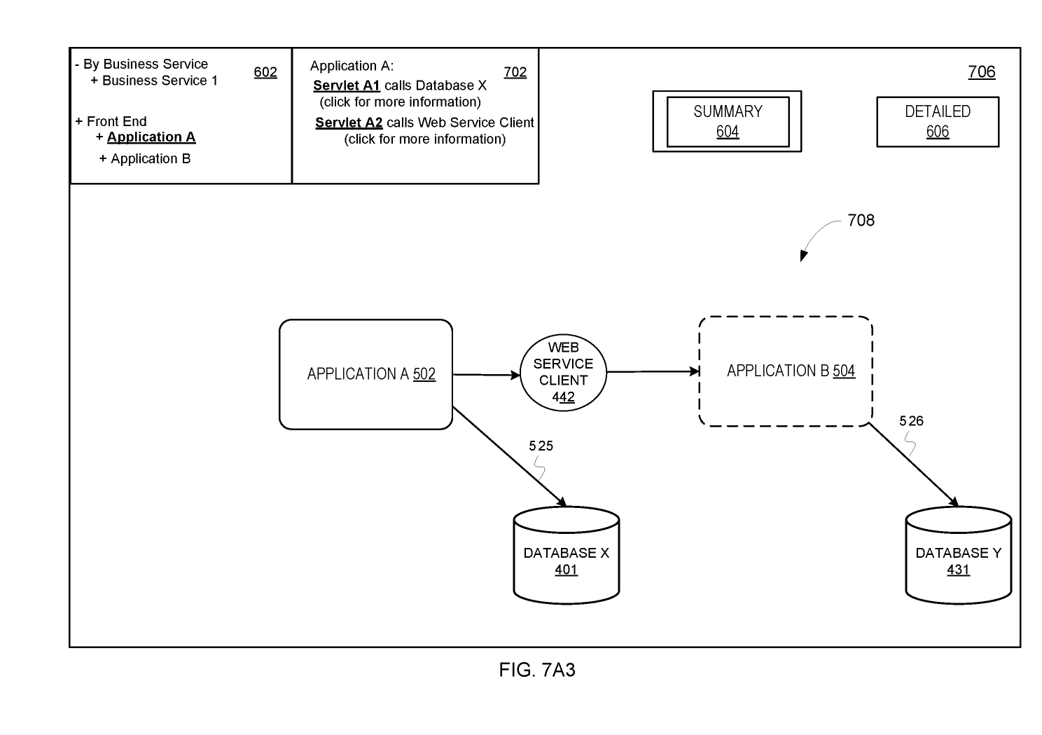

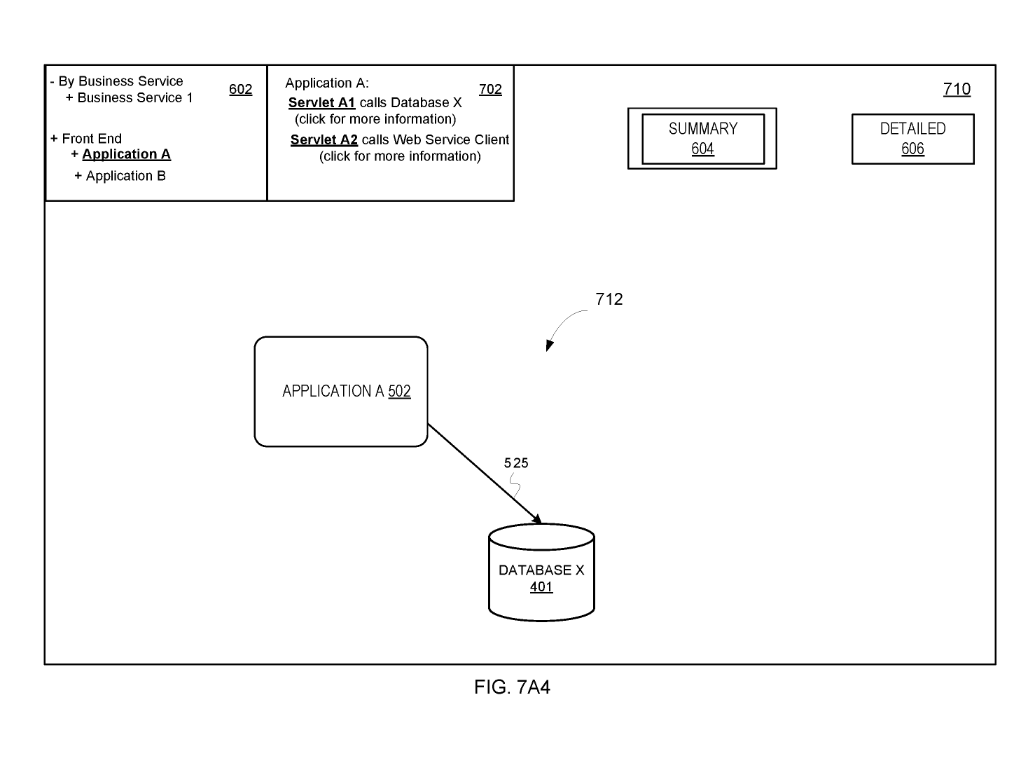

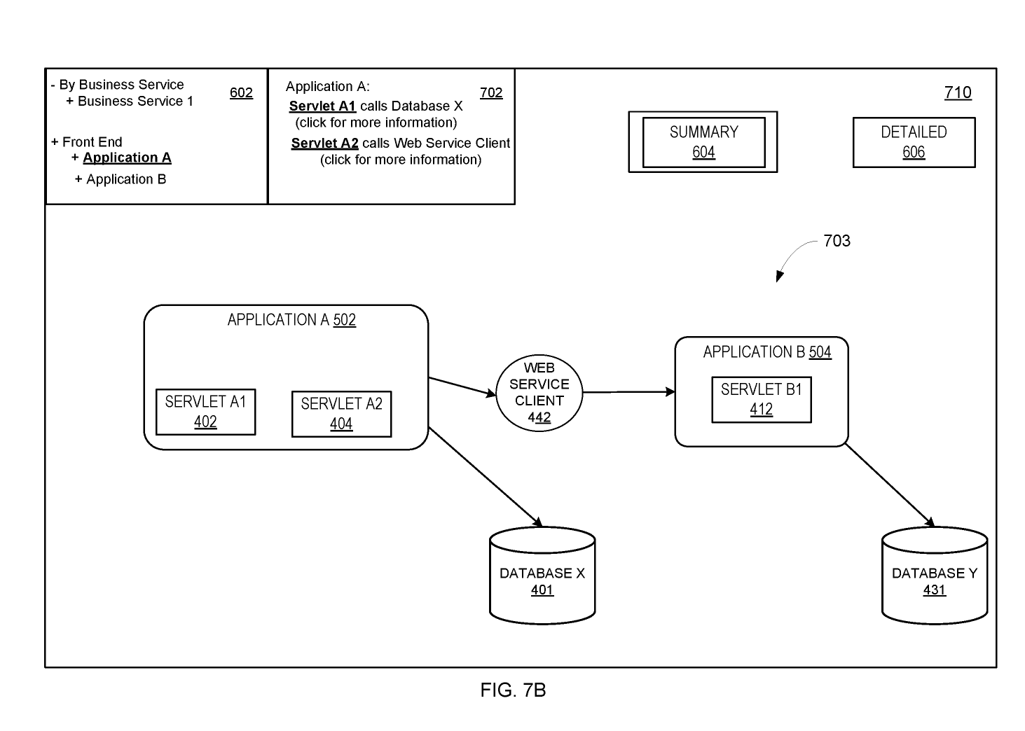

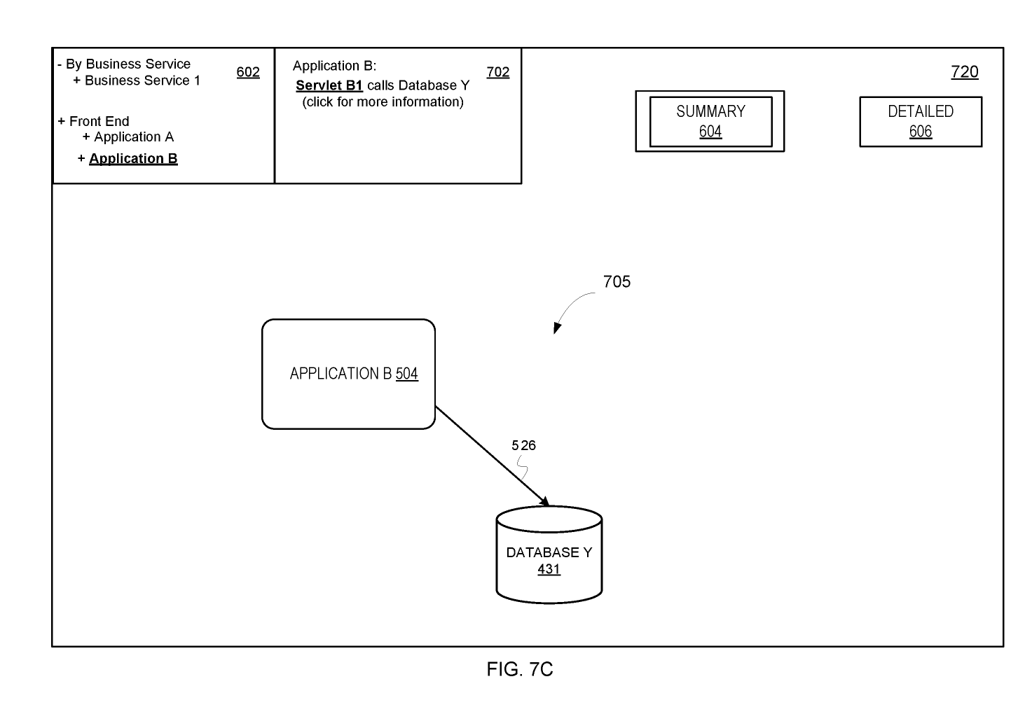

FIG. 7A1 depicts a user interface which provides a summary view based on the pruned dependency digraphs of FIGS. 4H and 4K, according to some embodiments. In this example, an Application A is selected in a front end view. This selection can be made by clicking on the Application A node 502 or via the tree region 602, where the selection is indicated by the highlighting of the Application A node. In the UI 700, the dependency graph 701 provides a front end view for Application A by identifying all nodes which it depends on, and the edges between these nodes, without regarding to a Business Transaction definition. An additional region 702 of the UI 700 can provide information for the selected node in the tree region 602. For example, the additional information includes the components of Application A and the components that they call. Specifically, Application A includes Servlet A1 which calls Database X, and Servlet A2 which calls a Web Service Client. Each component name can be a hyperlink which can be selected by the user to obtain additional component-specific information.

FIG. 7A2 depicts an aging process applied to the user interface of FIG. 7A1, according to some embodiments. An aging process can be applied in any of the dependency graphs to remove components which are less relevant because they have not been invoked recently. This helps to focus the user's diagnosis effort on alive transactions. The aging of vertices and edges can be based on the age of a last invoked edge. The age can be an elapsed time from the current time or from another reference time. If the age of an edge is older than a first threshold age, that edge can be rendered to have an aged appearance which is a different visual appearance compared to the nominal case where the age does not exceed the first threshold age. A vertex can be depicted with an aged appearance if all its incoming and outgoing edges have an aged appearance. Further, the vertices and edges can be removed from the dependency graph completely if the age exceeds a second threshold age, higher than the first threshold age. These threshold ages can be user-configurable. In the UI 704, in the dependency graph 711, a dotted line indicates that Database X, 401 and the edge 525 to it from Application A 502 indicates an aged appearance. Thus, the Database X node 401 and the edge 525 are older than the first threshold age. In this example, the (Application A, Database X) edge is still included in the view as its last reported date still falls within the removal window. That is, the age of the edge is greater than the first threshold age but less than the second threshold age.

In one scenario, consider Application A as a first application (represented by a first node 502) and Database X as one subsystem (represented by a second node 401) which Application A depends on. When an elapsed time since the first application (Application A) called the one subsystem (Database X) exceeds a threshold (first threshold age), the dependency graph graphically depicts aging of the second node (401). Or, when an elapsed time since the first application called the one subsystem exceeds a threshold (second threshold age), the dependency graph is updated to remove the second node.

FIG. 7A3 depicts another example of an aging process applied to the user interface of FIG. 7A1, according to some embodiments. The UI 706 provides a dependency graph 708. In another scenario, consider Application A as a first application (represented by a first node 502), Application B as one subsystem (represented by a second node 504) which Application A depends on, and Database Y as another subsystem (represented by a third node 431) which Application B depends on. The dependency graph can graphically depict: (d) the third node (431) which represents another subsystem, and (e) at least another edge (526) which represents a dependency of the one subsystem on the another subsystem. When an elapsed time since the first application called the one subsystem exceeds an associated threshold (first threshold age), and an elapsed time since the one subsystem called the another subsystem exceeds an associated threshold (first threshold age), the dependency graph can graphically depict aging of the second node. This aging is shown by the dotted border of the Application B node 504.

In another approach, when an elapsed time since the first application called the one subsystem exceeds an associated threshold (second threshold age), and an elapsed time since the one subsystem called the another subsystem exceeds an associated threshold (second threshold age), the dependency graph can be updated to remove the second node. This is indicated by FIG. 7A4. FIG. 7A4 depicts a further example of an aging process applied to the user interface of FIG. 7A1, according to some embodiments. The UI 710 provides a dependency graph 712. When a node is removed due to aging, all of the downstream nodes and edges can also be removed, in one approach. Further, a Web Service call to the node can be removed.

FIG. 7B depicts the user interface of FIG. 7A in a detailed view, according to some embodiments. In the UI 710, the button 606 for a detailed view is selected so that the dependency graph 703 identifies the components which are invoked in each application. In one approach, the detailed view of an application node displays the front end components for Business Transactions which involve the application. Specifically, within the Application A node 502, Servlet A1 402 and Servlet A2 404 nodes are displayed, and within the Application B node 504, the Servlet B1 node 412 is displayed. The edges are also modified so that they are connected to a specific component rather than to the application node.

The dependency graph can thus be alternatively provided in a summary view or a detailed view based on a user selection, where in the summary view, a first node (such as node 502) represents multiple instances of one application (e.g., Application A) of a number of respective applications without identifying invoked components of the multiple instances of the one of the respective applications, and in the detailed view, the first node represents the multiple instances of the one of the respective applications while identifying invoked components (e.g., Servlets A1, Servlet S2) of the multiple instances of the one of the respective applications.

FIG. 7C depicts a user interface which provides a summary view based on the pruned dependency digraph of FIG. 4K, according to some embodiments. In this example, an Application B is selected in a front end view. In the UI 720, the dependency graph 705 displays the Application B node 504, the Database Y node 431 and the edge 526. The nodes which are upstream of Application B and which call Application B are not displayed. This view allows the user to focus on a specific application and the subsystems it calls. The additional region 702 is updated to provide information regarding Servlet B1 in Application B.

### Example Multi-Perspective Displays of Dependencies

The previous section described the creation of dependency graphs to assist in analysis and visualization of dependencies among application components. This section includes a description of creation of multi-perspective displays of these dependencies among application components, so that the data can be interpreted based on different dimensions. Display of the same group of dependencies can vary depending on the perspective that is selected. Multiple perspectives of the dependency graph provide additional approaches for analyzing and visualizing dependencies among the application components. The application components typically have multiple attributes that help define themselves. These attributes can be detected by the agents or by a third-party discovery process or the end user. Attributes of application components can include the application to which they are associated. For example, if the components are grouped by the associated application name, a dependency graph can visualize dependencies of components across multiple applications, highlighting the application to application dependencies. Another example attribute of an application component is the host on which the component is executing. In particular, when components are grouped by the host names that host them, a dependency graph that highlights host-to-host dependencies can be formed, providing a host perspective for the user. Another example attribute of an application component is a type. For example, an application component can be a business transaction, a front end, a back end, a database, etc. Another example attribute is the owner of the application component. The owner can be an individual (e.g., the software developer), a business entity, etc. Attributes of the application components can be defined by the system, third-party software or by a user of the system.

Furthermore, these attribute based grouping can be defined in a nested manner. For instance, a user might choose to group components by their business unit and then by geography to quickly navigate business unit dependencies based on geographical distribution.

FIG. 8 depicts a no group perspective of a dependency graph of application components, according to some embodiments. A no group perspective 800 of a dependency graph of application components include a display in which the application components are not grouped based on an attribute.

FIG. 8 depicts eight different application components—a business transaction component 802, a front end component 804, a back end component 806, a back end component 808, a back end component 810, a business transaction component 812, a database interface component 814, and a database 816.

The business transaction component 802 can be a component of an application that is configured to provide a service as part of a business transaction. For example, the business transaction can be request to authenticate of a user, a request to checkout to purchase an item from a website, a request to access a user's checking account, etc.

The business transaction component 802 is coupled to the front end component 804. In this example, the business transaction component 802 is dependent on data or operations provided by the front end component 804. In this example, the front end component 804 is coupled to the back end component 806, the back end component 808, and the back end component 810. Thus, the front end component 804 is dependent on the back end components 806-810.

For example, in response to perform some operation from the business transaction component 802, the front end component 804 can transmit requests to the three back end components 806-810. Thus, the front end component 804 is dependent on the three back end components 806-810. As shown, the front end component 804 is coupled to each of the three back end components 806-810. To illustrate, the front end component 804 can request a user and password combination from the back end component 808. After receiving the user and password combination from the back end component 808, the back end components 806 and 810 perform operations to authenticate the user and password combination to authenticate a user as part of the business transaction.

The back end component 808 is coupled to the database interface component 814. Thus, the back end component 808 is dependent on the database interface component 814. For example, the back end component 808 can request the user and password combination for a particular user. The database interface component 814 is coupled to the database component 816. Thus, the database interface component 814 is dependent on the database component 818. For example, the database interface component 814 can access the user and password combination from the database component 818.

Additionally, a separate business transaction (the business transaction component 812) is coupled to the database interface component 814. The business transaction associated with the component 812 can be a separate from the business transaction associated with the component 802. For example, the business transaction component 812 can be request to obtain a balance for a user's checking account. Thus, the business transaction component can request that the database interface component 814 retrieve the balance for the user's checking account. In response, the database interface component 814 can retrieve the balance from the database component 816.

Alerts that can be triggered (triggerable alerts) can also be assigned to an application component. The alerts can be an indicator of some event occurring related to execution of the application component. For example, a triggerable alert can be assigned such that if response from an application component takes longer than a defined time (e.g., two seconds), an alert is triggered. In another example, a triggerable alert can be triggered if no response is received from an application component. Any number of triggerable alerts can be assigned to an application component.

The display of the perspectives for the application components can include a display of the number of alerts that have been triggered and the number of triggerable alerts assigned to an application component. With reference to the no group perspective 800, the business transaction component 812 and the database interface component 814 include display of the number of alerts triggered in comparison to the number of alerts that can be triggered (triggerable alerts). The business transaction component 812 includes alerts 850 that include one triggered alert out of five triggerable alerts. Similarly, the database interface component 814 includes alerts 852 that include one triggered alert out of five triggerable alerts.

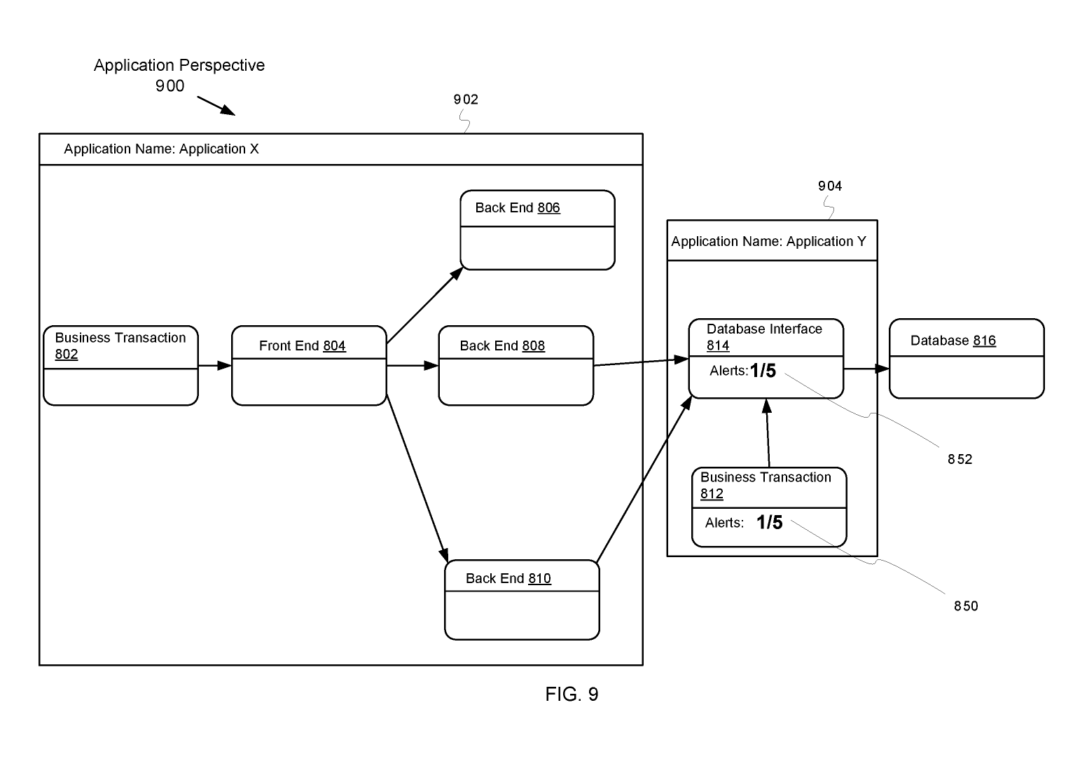

FIG. 9 depicts an application perspective of a dependency graph of application components, according to some embodiments. FIG. 9 depicts an application perspective 900 that includes the same application components depicted in FIG. 8 but with grouping according to application association. Specifically, the application perspective 900 displays the application components being grouped together based on the attribute of which application does the application component belong. The application components having a same value for a selected attribute (the application) are grouped into a same container. Thus for this example depicted in FIG. 9, the application components that are part of a same application are grouped together. The dependencies among the application components remain the same. However, FIG. 9 provides a perspective of dependency based on application.

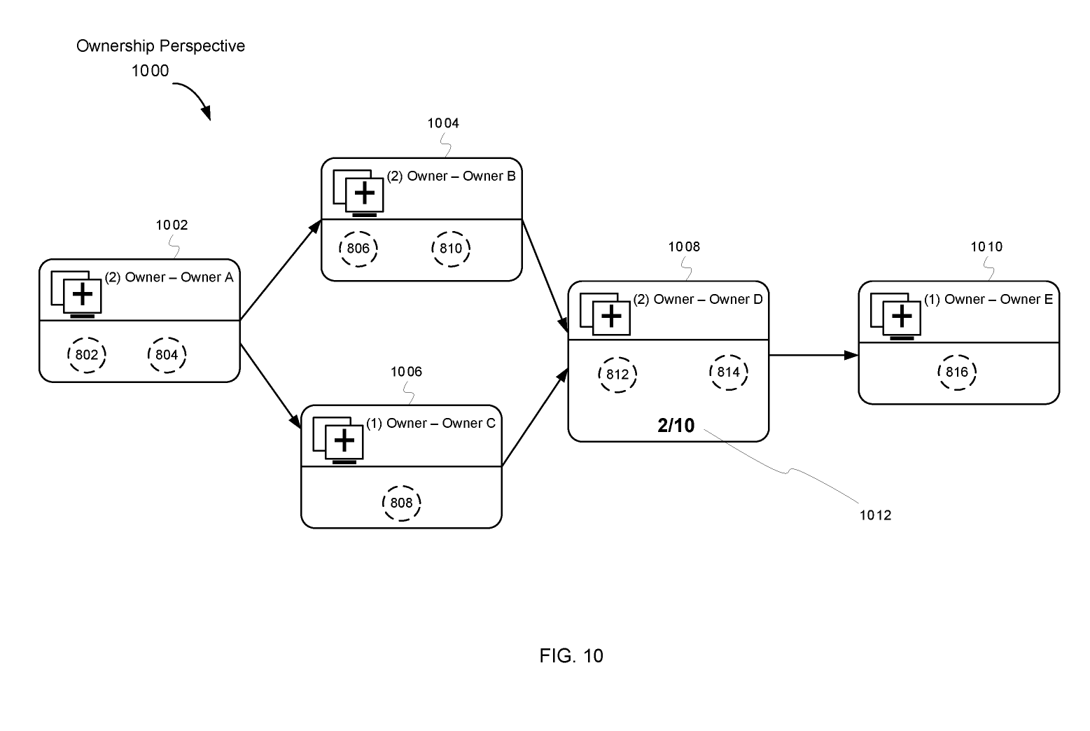

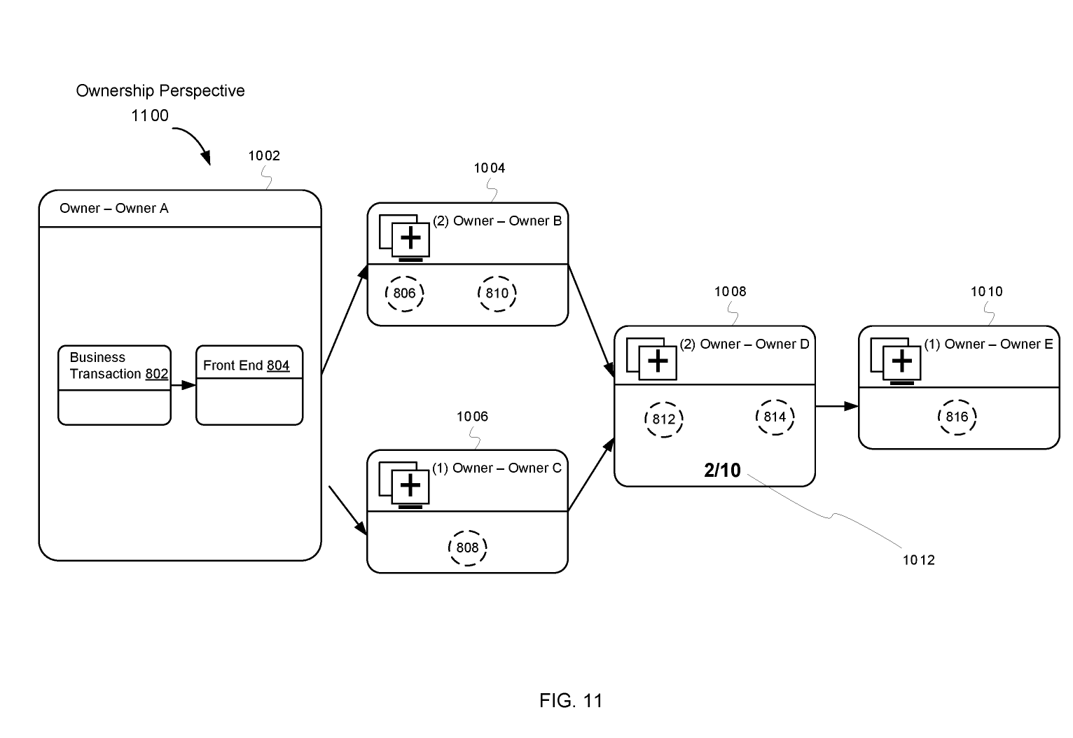

Note, the application perspective 900 provides an expanded view of the containers such that the application components are displayed within the containers. This is in contrast to a collapsed view of the containers such that the application components are not displayed. One example of a collapsed view is depicted in FIG. 10, which is described below. Alternatively, a perspective can be a combination of expanded and collapsed views. For example, one container in a perspective can be expanded to show the application components, while a different container in the perspective is collapsed. The expansion and collapsing of containers can occur in response to user input (e.g., a button selection).

In this example, a container 902 includes a grouping of application components that are part of an Application X. The business transaction component 802, the front end component 804, the back end component 806, the back end component 808, and the back end component 810 are part of the execution of Application X.

A container 904 includes a group of application components that are part of an Application Y. The business transaction component 812 and the database interface component 814 are part of the execution of Application Y. The database component 816 is not assigned to any application. Thus, the database component 816 is not included in an application container.

FIG. 10 depicts an ownership perspective of a dependency graph of application components, according to some embodiments. FIG. 10 depicts an ownership perspective 1000 that includes the same application components depicted in FIG. 8 but with grouping according to ownership of the application component. Specifically, the ownership perspective 1000 displays the application components being grouped together based on the attribute of who is the defined owner. The owner of an application component can be an individual (e.g., the software developer or programmer), the business entity or group within the business entity responsible for the application component, etc.

The application components having a same value for a selected attribute (the owner) are grouped into a same container. Thus for this example depicted in FIG. 10, the application components having a same owner are grouped together. The dependencies among the application components remain the same. However, FIG. 10 provides a perspective of dependency based on ownership.

The ownership perspective 1000 provides a collapsed view of the containers such that the application components are not displayed. Dashed circles have been added in the collapsed containers to help illustrate where the application components are located. However, these dashed circles are typically not displayed for a collapsed view.

In this example, a container 1002 includes a grouping of application components having a same owner—Owner A. The container 1002 includes the business transaction component 802 and the front end component 804. At least one application component in the container 1002 is dependent on an application component in a container 1004 (shown by the arrow between the container 1002 and the container 1004). The container 1004 includes a grouping of application components having a same owner—Owner B. The container 1004 includes the back end component 806 and the back end component 810.

At least one application component in the container 1002 is also dependent on an application component in a container 1006 (shown by the arrow between the container 1002 and the container 1006). The container 1006 includes a grouping of application components having a same owner—Owner C. The container 1006 includes the back end component 808.

At least one application component in the container 1004 and at least one application component in the container 1006 are dependent on an application component in a container 1008 (shown by the arrow between the container 1004 and the container 1008 and the arrow between the container 1006 and the container 1008). The container 1008 includes a grouping of application components having a same owner—Owner D. The container 1008 includes the business transaction component 812 and the database interface component 814.

At least one application component in the container 1008 is dependent on an application component in a container 1010 (shown by the arrow between the container 1008 and the container 1010). The container 1010 includes a grouping of application components having a same owner—Owner E. The container 1010 includes the database component 816.

The ownership perspective 1000 also displays alerts 1012 which is a combination of alerts from all the application components in the container 1008. In this example, the alerts 1012 are the combination of alerts from the business transaction component 812 and the database interface component 814. The container 1008 includes the alerts 1012 that include two triggered alerts out of 10 triggerable alerts.

FIG. 11 depicts an alternative ownership perspective of a dependency graph of application components, according to some embodiments. FIG. 11 depicts an ownership perspective 1100 that includes the same containers depicted in FIG. 10 but with an expanded view of the container 1002. The expanded view of the container 1002 includes the business transaction component 802 and the front end component 804. The other containers in the ownership perspective 1100 remain in a collapsed view.

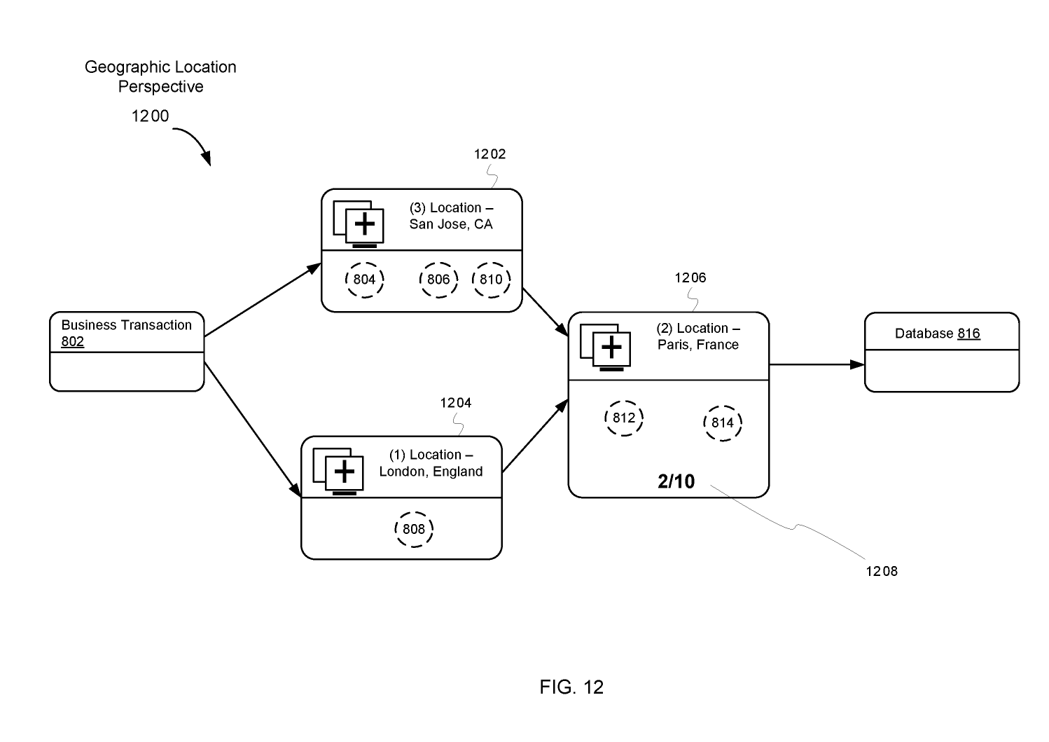

FIG. 12 depicts a geographic location perspective of a dependency graph of application components, according to some embodiments. FIG. 12 depicts a geographic location perspective 1200 that includes the same application components depicted in FIG. 8 but with grouping according to geographic location where the application components are executed. The application components having a same value for a selected attribute (the geographic location) are grouped into a same container. Thus for this example depicted in FIG. 12, the application components executing in a same geographic location are grouped together. The dependencies among the application components remain the same. However, FIG. 12 provides a perspective of dependency based on geographic location.

The ownership perspective 1200 provides a collapsed view of the containers such that the application components are not displayed. Dashed circles have been added in the collapsed containers to help illustrate where the application components are located. However, these dashed circles are typically not displayed for a collapsed view. In this example, the business transaction component 802 and the database component 816 have not been assigned a geographic location. Therefore, the business transaction component 802 and the database component 816 are not placed into a container.

The business transaction component 802 is dependent on at least one application component in a container 1202. The container 1202 includes a grouping of application components executing in a same geographic location—San Jose, Calif. The container 1202 includes the front end component 804, the back end component 806, and the back end component 810. The business transaction component 802 is also dependent on at least one application component in a container 1204. The container 1204 includes a grouping of application components executing in a same geographic location—London, England. The container 1204 includes the back end component 808.

At least one application component in the container 1202 and at least one application component in the container 1204 are dependent on an application component in a container 1206 (shown by the arrow between the container 1202 and the container 1206 and the arrow between the container 1204 and the container 1206). The container 1206 includes a grouping of application components executing in a same geographic location—Paris, France. The container 1206 includes the business transaction component 812 and the database interface component 814. At least one application component in the container 1206 is dependent on the database component 816 (shown by the arrow between the container 1206 and the database component 816).

The geographic location perspective 1200 also displays alerts 1208 which is a combination of alerts from all the application components in the container 1206. In this example, the alerts 1208 are the combination of alerts from the business transaction component 812 and the database interface component 814. The container 1206 includes the alerts 1208 that include two triggered alerts out of 10 triggerable alerts.

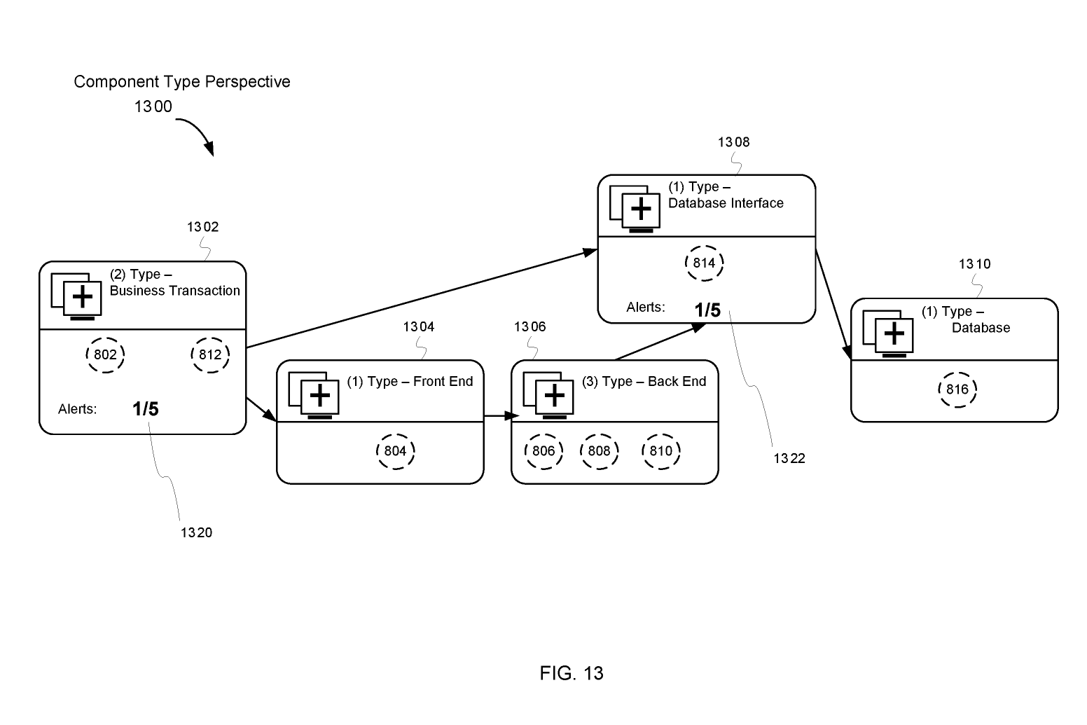

FIG. 13 depicts a component type perspective of a dependency graph of application components, according to some embodiments. FIG. 13 depicts a component type perspective 1300 that includes the same application components depicted in FIG. 8 but with grouping according to the types of application components. The application components having a same value for a selected attribute (the component type) are grouped into a same container. Thus for this example depicted in FIG. 13, the application components that are of a same type are grouped together. The dependencies among the application components remain the same. However, FIG. 13 provides a perspective of dependency based on component type.

The component type perspective 1300 provides a collapsed view of the containers such that the application components are not displayed. Dashed circles have been added in the collapsed containers to help illustrate where the application components are located. However, these dashed circles are typically not displayed for a collapsed view.

In this example, a container 1302 includes a grouping of application components of a same component type—Business Transaction. The container 1302 includes the business transaction component 802 and the business transaction component 812. At least one application component in the container 1302 is dependent on an application component in a container 1304 (shown by the arrow between the container 1302 and the container 1304). The container 1304 includes a grouping of application components of a same component type—Front End. The container 1304 includes the front end component 804.

At least one application component in the container 1302 is also dependent on an application component in a container 1308 (shown by the arrow between the container 1302 and the container 1308). The container 1308 includes a grouping of application components of a same component type—Database Interface. The container 1308 includes the database interface component 814.

At least one application component in the container 1304 is dependent on an application component in a container 1306 (shown by the arrow between the container 1304 and the container 1306). The container 1306 includes a grouping of application components of a same component type—Back End. The container 1306 includes the back end component 806, the back end component 808, and the back end component 810.

At least one application component in the container 1308 is dependent on an application component in a container 1310 (shown by the arrow between the container 1308 and the container 1310). The container 1310 includes a grouping of application components of a same component type—Database. The container 1310 includes the database component 816.

The component type perspective 1300 also displays alerts. The container 1302 includes alerts 1320 that include one triggered alert out of five triggerable alerts. Similarly, the container 1308 includes alerts 1322 that include one triggered alert out of five triggerable alerts.

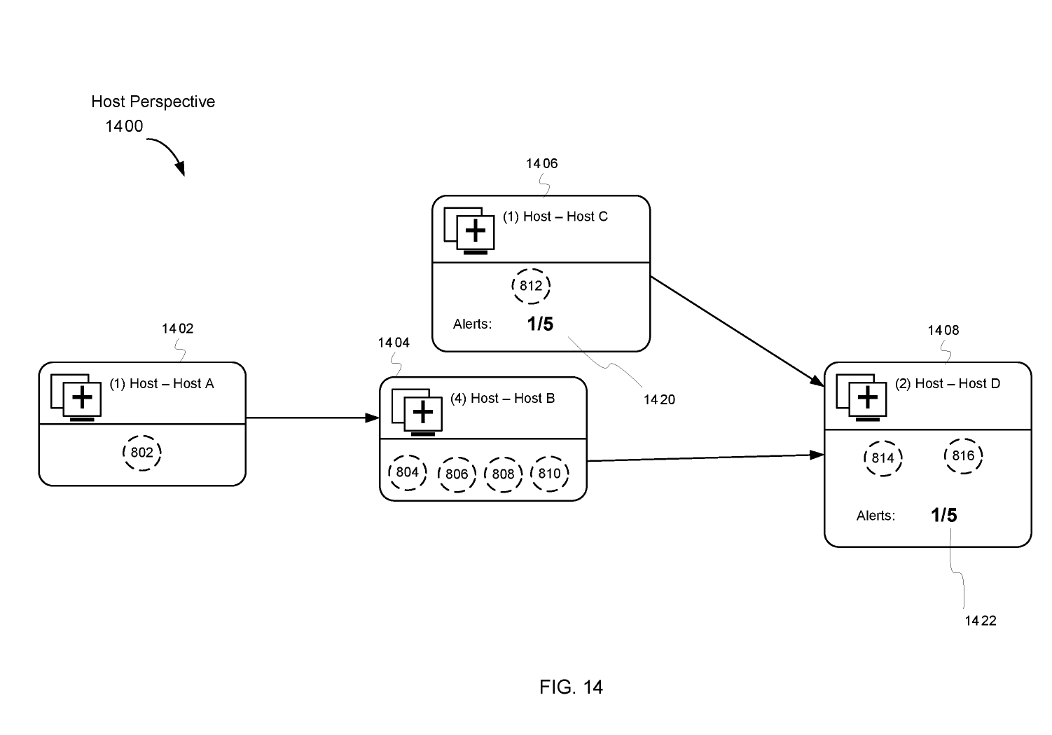

FIG. 14 depicts a host perspective of a dependency graph of application components, according to some embodiments. FIG. 14 depicts a host perspective 1400 that includes the same application components depicted in FIG. 8 but with grouping according to what host is executing the application components.

The application components having a same value for a selected attribute (the host) are grouped into a same container. Thus for this example depicted in FIG. 14, the application components that are hosted by a same server, device, etc. are grouped together. The dependencies among the application components remain the same. However, FIG. 14 provides a perspective of dependency based on host.

The component type perspective 1400 provides a collapsed view of the containers such that the application components are not displayed. Dashed circles have been added in the collapsed containers to help illustrate where the application components are located. However, these dashed circles are typically not displayed for a collapsed view.

In this example, a container 1402 includes a grouping of application components that are hosted by a same device—Host A. The container 1402 includes the business transaction component 802. At least one application component in the container 1402 is dependent on an application component in a container 1404 (shown by the arrow between the container 1402 and the container 1404). The container 1404 includes a grouping of application components hosted by a same device—Host B. The container 1404 includes the front end component 804, the back end component 806, the back end component 808, and the back end component 810.

A container 1406 includes a grouping of application components that are hosted by a same device—Host C. The container 1406 includes the business transaction component 812. At least one application component in the container 1406 is dependent on an application component in a container 1408 (shown by the arrow between the container 1406 and the container 1408).

At least one application component in the container 1404 is also dependent on an application component in a container 1408 (shown by the arrow between the container 1404 and the container 1408). The container 1408 includes a grouping of application components hosted by a same device—Host D. The container 1408 includes the database interface component 814 and the database component 816.

The component type perspective 1400 also displays alerts. The container 1406 includes alerts 1420 that include one triggered alert out of five triggerable alerts. Similarly, the container 1408 includes alerts 1422 that include one triggered alert out of five triggerable alerts.

FIGS. 9-14 depicted different perspectives based on example attributes of the application components. Some embodiments can include perspectives based on other types of attributes. For example, another perspective can be based on a geographic region (not a specific location necessarily). To illustrate, one group of application components can be executing in the west coast of the United States, while another group of application component can be executing in the southern region of China. Other example attributes can include type of compiler, type of programming language, type of operating system, etc.

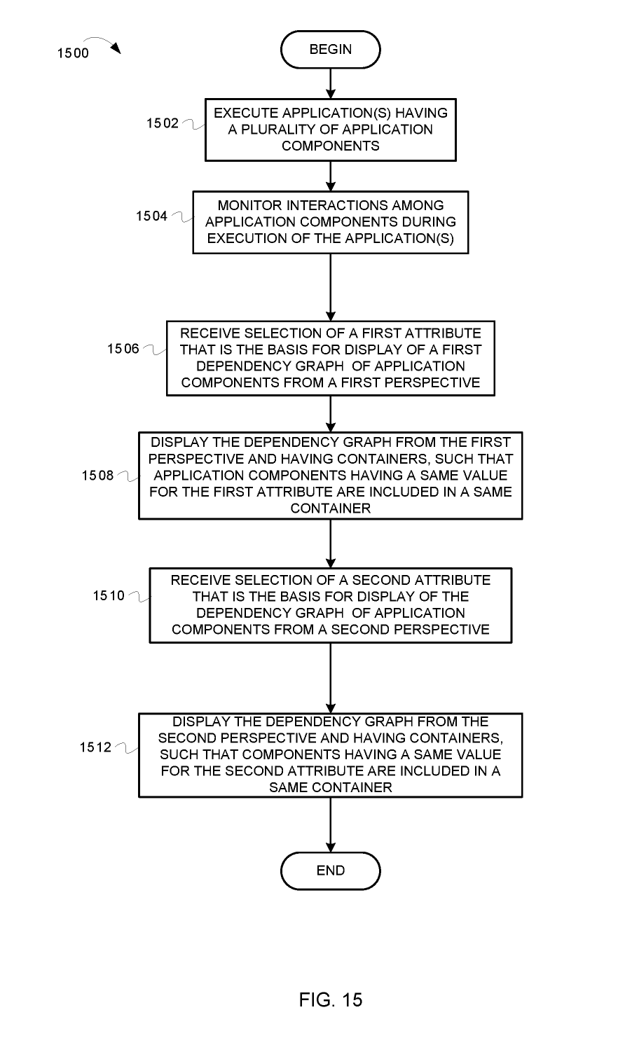

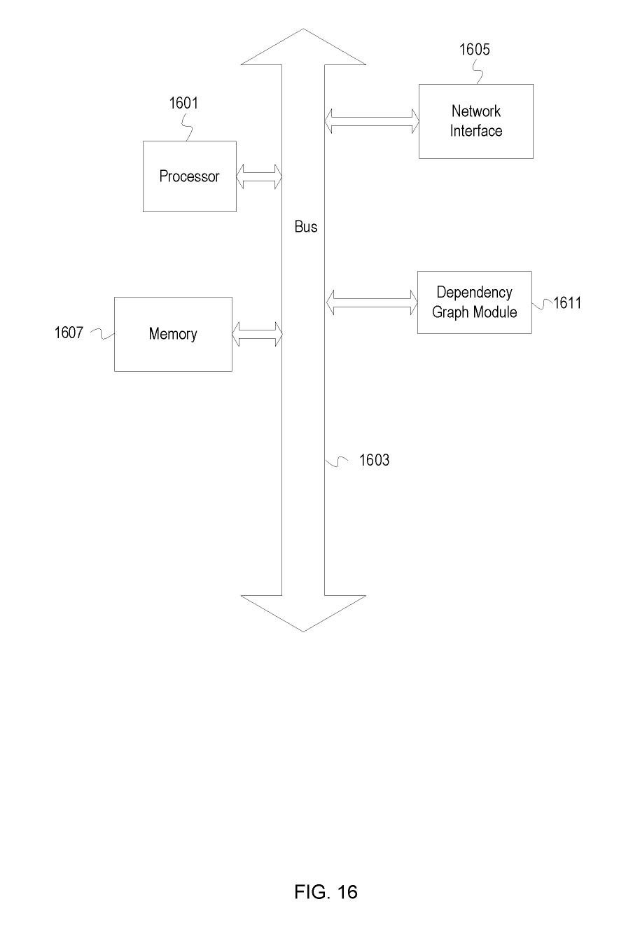

FIG. 15 depicts a flowchart of operations for providing multiple perspectives of a dependency graph of application components, according to some embodiments. Operations of a flowchart 1500 can be performed by software, firmware, hardware or a combination thereof. For example, operations can be performed by a dependency graph module 1611 depicted in FIG. 16, described below. For sake of simplicity, operations of the flowchart 1500 include a change from a first perspective to a second perspective based on selection of two different attributes. However, operations of the flowchart 1500 can include continue to change to any number of perspectives based on selecting of different attributes. Operations of the flowchart 1500 start at block 1502.

Application(s) having a number of application components is executed (1502). With reference to FIGS. 8-14, the application for initiating an online business transaction (e.g., accessing checking account balance) can be executed. Other applications (related or unrelated) can also be executed.

Interactions among the application components are monitored during execution of the application(s) (1504). Monitoring of the interactions among the application components is described above in the creating of the dependency graphs, described above in reference to FIGS. 1-7.

Selection is received of a first attribute that is the basis for display of a first dependency graph of the application components from a first perspective (1506). For example, with reference to FIG. 10, the first attribute to be selected can be the ownership attribute. The selection can be made by a user or programmatically by some type of monitoring module.

A dependency graph from the first perspective is displayed (1508). The dependency graph can include a number of containers such that application components having a same value for the selected attribute are included in a same container. For example, with reference to FIG. 10, the first perspective is an ownership perspective having five containers for five different owners. The container 1002 includes two application components and is associated with Owner A. The container 1004 includes two application components and is associated with Owner B. The container 1006 includes one application component and is associated with Owner C. The container 1008 includes two application components and is associated with Owner D. The container 1010 includes one application component and is associated with Owner E.

Selection is received of a second attribute that is the basis for display of the dependency graph of the application components from a second perspective (1510). For example, with reference to FIG. 13, the second attribute to be selected can be the component type attribute. The selection can be made by a user or programmatically by some type of monitoring module.

The dependency graph from the second perspective is displayed (1512). The dependency graph can include a number of containers such that application components having a same value for the selected attribute are included in a same container. For example, with reference to FIG. 13, the second perspective is a component type perspective having five containers for five different component types. The container 1302 includes two application components and is for Business Transaction component types. The container 1304 includes one application component and is for Front End component types. The container 1306 includes three application components and is for Back End component types. The container 1308 includes one application component and is for Database Interface component types. The container 1310 includes one application component and is for Database component types.

### Example Computer Device

FIG. 16 depicts an example computer device, according to some embodiments. The computer device includes a processor 1601 (possibly including multiple processors, multiple cores, multiple nodes, and/or implementing multi-threading, etc.). The computer device includes memory 1607. The memory 1607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. For example, the memory 1607 can represent the memory 112 depicted in FIG. 1.

The computer device also includes a persistent data storage 1609. The persistent data storage 1609 can be a hard disk drive, such as magnetic storage device. The computer device also includes a bus 1603 (e.g., PCI, ISA, PCI-Express, HyperTransport® bus, InfiniBand® bus, NuBus, etc.) and a network interface 1605 (e.g., a Fiber Channel interface, an Ethernet interface, an internet small computer system interface, SONET interface, wireless interface, etc.).

The computer device also includes a dependency graph module 1611. The dependency graph module 1611 can perform operations to create and display dependency graphs and the multiple perspectives of the dependency graphs, as described above. Any one of the previously described functionalities may be partially (or entirely) implemented in hardware and/or on the processor 1601. For example, the functionality may be implemented with an application specific integrated circuit, in logic implemented in the processor 1601, in a co-processor on a peripheral device or card, etc. Further, realizations may include fewer or additional components not illustrated in FIG. 16 (e.g., video cards, audio cards, additional network interfaces, peripheral devices, etc.). The processor 1601, the network interface 1605, and the persistent data storage 1609 are coupled to the bus 1603. Although illustrated as being coupled to the bus 1603, the memory 1607 may be coupled to the processor 1601.

### Variations

These multi-perspective dependency graphs can be output for a user to review, change perspectives, etc. In some embodiments, these graphs can be used programmatically by software, hardware, etc. In particular, these graphs can be used programmatically to analyze application(s) deployments. For instance, these graphs can be used as lookup structures. Based on the lookup structures, errors originating from a component can be routed to the correct owner, business unit, etc. to provide notification of such errors.

Additionally, some embodiments can be used to identify a distinguishing attribute that provides a perspective that provides a minimum number of groupings that include alerts. To help illustrate, FIG. 13 includes a perspective based on component type. In this example, the alerts are spread across two containers. Specifically, the container 1302 includes the alerts 1320, the container 1308 includes alerts 1322. However, FIG. 12 includes a perspective based on geographic location. In this example, the alerts are within one container (the container 1206 having the alerts 1208). Thus, in this example, the distinguishing attribute would be geographic location. This identification of the distinguishing attribute can help isolate the errors causing the alerts. For example, from FIG. 12, the geographic location of Paris, France (the container 1206) can be the cause of the errors causing the alerts, since all of the alerts are within the container 1206. This identifying of a distinguishing attribute can be performed by a user or programmatically.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

While the aspects of the disclosure are described with reference to various implementations and exploitations, it will be understood that these aspects are illustrative and that the scope of the claims is not limited to them. In general, techniques for creation and display of dependency graphs and multiple perspectives of dependency graphs as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
creating a dependency graph that indicates dependencies among a plurality of components of an application based, at least in part, on interactions among the plurality of components determined from at least one execution of the application;
in response to selection of a first attribute of a plurality of attributes, differentiating the plurality of components into a first plurality of sets of the plurality of components based, at least in part, on having values in common for the first attribute;
determining dependencies among the first plurality of sets of components based, at least in part, on the dependency graph; and
displaying a first attribute based perspective of the application, wherein the first attribute based perspective comprises a graphical container for each of the first plurality of sets of components and graphical connections between the graphical containers corresponding to the dependencies among the first plurality of sets of components.

2. The method of claim 1 further comprising:
presenting, via a user interface, a graphical depiction of the dependency graph prior to selection of the first attribute, wherein the graphical depiction depicts the plurality of components and the dependencies,
wherein displaying comprises updating the user interface to graphically rearrange the graphical depiction of the plurality of components to be within respective ones of the graphical containers.

3. The method of claim 1 further comprising determining the interactions among the plurality of components from at least one execution of the application.

4. The method of claim 1 further comprising:
in response to selection of a second attribute of the plurality of attributes, differentiating the plurality of components into a second plurality of sets of the plurality of components based, at least in part, on having values in common for the second attribute;
determining dependencies among the second plurality of sets of components based, at least in part, on the dependency graph; and
displaying a second attribute based perspective of the application, wherein the second attribute based perspective comprises a graphical container for each of the second plurality of sets of components and graphical connections between the graphical containers corresponding to the dependencies among the second plurality of sets components.

5. The method of claim 4 further comprising:
iteratively selecting each of a set of the plurality of attributes; and
storing each attribute based perspective displayed based on the iterative selections.

6. The method of claim 5,
wherein each graphical container includes any alerts associated with components contained in the graphical container, wherein each of the alerts provides a notification of at least one of an error and performance issue associated with a component,
wherein the method comprises traversing through each attribute based perspective to identify at least one attribute based perspective that includes a minimum number of containers having alerts.

7. The method of claim 6 further comprising:
determining a responsible entity of components having the alerts; and
transmitting, to the responsible entity, notification of the alerts.

8. The method of claim 1, wherein the plurality of attributes comprise at least one of an owner of the component and a geographic location where the component is being executed.

9. One or more machine-readable storage media having program code stored therein, the program code comprising instructions to:
determine dependencies among a plurality of components for an application based, at least in part, on interactions among the plurality of components observed from at least one execution of the application;
in response to selection of an attribute from a plurality of attributes associated with the plurality of components, determine components of the plurality of components that have values in common for the selected attribute; and
graphically organize the plurality of components into graphical containers based, at least in part, on the determination of components with values in common for the selected attribute.

10. The one or more machine-readable storage media of claim 9, wherein the program code comprises instructions to:
present, via a user interface, a graphical depiction of a dependency graph that includes the dependencies among the plurality of components prior to selection of the attribute; and
update the user interface to graphically rearrange the graphical depiction of the plurality of components to be within respective ones of the graphical containers.

11. The one or more machine-readable storage media of claim 9, wherein the program code comprises instructions to determine the interactions among the plurality of components from at least one execution of the application.

12. The one or more machine-readable storage media of claim 9, wherein the plurality of attributes comprise at least one of an owner of the component and a geographic location where the component is being executed.

13. An apparatus comprising:
a processor; and
a machine-readable medium having program code executable by the processor to cause the apparatus to:
create a dependency graph that indicates dependencies among a plurality of components of an application based, at least in part, on interactions among the plurality of components determined from at least one execution of the application;
in response to selection of a first attribute of a plurality of attributes, differentiate the plurality of components into a first plurality of sets of the plurality of components based, at least in part, on having values in common for the first attribute;
determine dependencies among the first plurality of sets of components based, at least in part, on the dependency graph; and
display a first attribute based perspective of the application, wherein the first attribute based perspective comprises a graphical container for each of the first plurality of sets of components and graphical connections between the graphical containers corresponding to the dependencies among the first plurality of sets of components.

14. The apparatus of claim 13, wherein the program code comprises program code to cause the apparatus to:
present, via a user interface, a graphical depiction of the dependency graph prior to selection of the first attribute, wherein the graphical depiction depicts the plurality of components and the dependencies,
wherein the program code to cause the apparatus to display comprises program code to cause the apparatus to update the user interface to graphically rearrange the graphical depiction of the plurality of components to be within respective ones of the graphical containers.

15. The apparatus of claim 13, wherein the program code comprises program code to cause the apparatus to determine the interactions among the plurality of components from at least one execution of the application.

16. The apparatus of claim 13, wherein the program code comprises program code to cause the apparatus to:
in response to selection of a second attribute of the plurality of attributes, differentiate the plurality of components into a second plurality of sets of the plurality of components based, at least in part, on having values in common for the second attribute;
determine dependencies among the second plurality of sets of components based, at least in part, on the dependency graph; and
display a second attribute based perspective of the application, wherein the second attribute based perspective comprises a graphical container for each of the second plurality of sets of components and graphical connections between the graphical containers corresponding to the dependencies among the second plurality of sets components.

17. The apparatus of claim 16, wherein the program code comprises program code to cause the apparatus to:
iteratively select each of a set of the plurality of attributes; and
store each attribute based perspective displayed based on the iterative selections.

18. The apparatus of claim 17,
wherein each graphical container includes any alerts associated with components contained in the graphical container, wherein each of the alerts provides a notification of at least one of an error and performance issue associated with a component,
wherein the program code comprises program code to cause the apparatus to traverse through each attribute based perspective to identify at least one attribute based perspective that includes a minimum number of containers having alerts.

19. The apparatus of claim 18, wherein the program code comprises program code to cause the apparatus to:
determine a responsible entity of components having the alerts; and
transmit, to the responsible entity, notification of the alerts.

20. The apparatus of claim 13, wherein the plurality of attributes comprise at least one of an owner of the component and a geographic location where the component is being executed.
